(19) United States
(12) Patent Application Publication
(10) Pub. No.: US 2006/0205599 A1
(43) Pub. Date: Sep. 14, 2006

(54) Herbicide combinations comprising specific sulfonamides

(75) Inventors: Erwin Hacker, Hochheim (DE); Martin Hess, Mainz-Bretzenheim (DE); Frederic Top, Leverkusen (DE); Wolfgang Benz, Burscheid (DE); Markus Dollinger, Leverkusen (DE)

Correspondence Address: Connolly Bove Lodge & Hutz LLP, 1007 North Orange Street, P.O. Box 2207, Wilmington, DE, 19899, US

(73) Assignee: Bayer CropScience GmbH

(21) Appl. No.: 11/400,463

(22) Filed: Apr. 6, 2006

Related U.S. Application Data
(63) Continuation of application No. 10/900,897, filed on Jul. 28, 2004.

(30) Foreign Application Priority Data
Jul. 28, 2003 (DE) DE 10334302.4

(51) Int. Cl. A01N 43/60

(52) U.S. Cl. 504/136

(57) ABSTRACT

Herbicide combinations having an effective content of components (A), (B) and (C) have improved properties as crop protection compositions:
(A) is one or more herbicides selected from the group consisting of the compounds of the formula (I) and their salts, 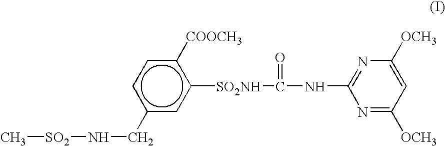
(B) is one or more herbicides selected from the group consisting of the compounds of the formula (II) and their salts, 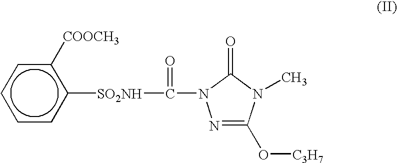 (C) is one or more herbicides which act selectively in some monocotyledonous crops against monocotyledonous and/or dicotyledonous harmful plants, which herbicides are selected from the group consisting of the compounds (C1) diflufenican, (C2) imazamox, (C3) florasulam, (C4) halosulfuron, (C5) tritosulfuron, (C6) picolinafen, (C7) cinidon-ethyl, (C8) mesotrione, (C9) metosulam, (C10) copyralid, (C11) flufenacet, (C12) flumetsulam, (C13) flupoxam, (C14) prosulfocarb, (C15) flurtamone, (C16) aclonifen, (C17) fenoxaprop, (C18) isoproturon, (C19) diclofop, (C20) clodinafop, (C21) chlortoluron, (C22) methabenzthiazuron, (C23) imazamethabenz, (C24) tralkoxydim, (C25) difenzoquat, (C26) flamprop, (C27) pendimethalin, (C28) mecoprop, (C29) MCPA, (C30) dichlorprop, (C31) 2,4-D, (C32) dicamba, (33) fluroxypyr, (C34) ioxynil, (C35) bromoxynil, (C36) bifenox, (C37) fluoroglycofen, (C38) lactofen, (C39) pyraflufen, (C40) flucarbazone, (C41) bentazone, (C42) amidosulfuron, (C43) metsulfuron, (C44) tribenuron, (C45) thifensulfuron, (C46) triasulfuron, (C47) chlorsulfuron, (C48) flupyrsulfuron, (C49) fluazolate, (C50) sulfosulfuron, (C51) glufosinate, (C52) glyphosate, (C53) sulcotrione, (C54) cycloxydim, (C55) sethoxydim, (C56) clethodim, (C57) carfentrazone, (C58) imazethapyr, (C59) imazaquin, (C60) imazapyr, (C61) imazapic, (C62) beflubutamid, (C63) fentrazamide, (C64) flufenacet and (C65) amicarbazone.

The invention is in the technical field of crop protection compositions which can be used against harmful plants, for example in crop plants, and which comprise, as active compounds, a combination of at least three herbicides.

Sulfonamides and their salts and their use as herbicides and/or plant growth regulators are known from the publications U.S. Pat. No. 5,534,486 and WO 95/10507.

The effectiveness of these herbicides against harmful plants in the crop plants is at a high level; however, it depends in general on the application rate, the respective formulation, the harmful plants to be controlled in each case or the spectrum of harmful plants, the climatic and soil conditions, etc. A further criterion is the duration of the action, or the rate of degradation of the herbicide. Also to be taken into account are, if appropriate, changes in the sensitivity of harmful plants which may occur on prolonged use of the herbicides or in geographical locations. Activity losses in individual harmful plants can only be compensated to a certain extent by higher application rates of the herbicides, for example because this frequently decreases the selectivity of the herbicides, or an improvement in activity is not observed, even at higher application rates. In some cases, it is possible to improve the selectivity in crops by addition of safeners. In general, however, there is always a need for methods to achieve the herbicidal action with a lower application rate of active compounds. A lower application rate reduces not only the amount of an active compound which is required for the application, but generally also reduces the amount of formulation auxiliaries required. Both reduce the economic expense and improve the ecological compatibility of the herbicide treatment.

A possibility for improving the property profile of a herbicide may consist in the combination of the active compound with one or more other active compounds which contribute the desired additional properties. However, when two or more active compounds are applied in combination, it is not uncommon for phenomena of physical and biological incompatibility to occur, for example lack of stability of a coformulation, decomposition of an active compound or antagonism of the active compounds. In contrast, what is desired are combinations of active compounds having a favorable activity profile, high stability and as synergistically enhanced an activity as possible which permits a reduction of the application rate, compared with the individual application of the active compounds to be combined.

Surprisingly, it has now been found that certain herbicidal compounds from the group of the sulfonamides and their salts interact in a particularly favorable manner in combination with certain structurally different herbicides, for example when they are used in crop plants in which the herbicides, if appropriate with added safeners, can act selectively.

Accordingly, the invention provides herbicide combinations having an effective content of components (A), (B) and (C) where
(A) is one or more herbicides selected from the group consisting of the compounds of the formula (I) and their salts, 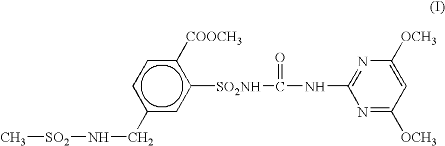
(B) is one or more herbicides selected from the group consisting of compounds of the formula (II) and their salts, 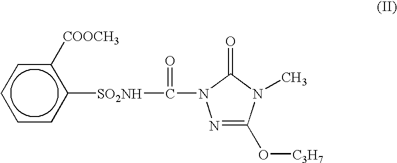
(C) is one or more herbicides which act selectively in some monocotyledonous crops against monocotyledonous and/or dicotyledonous harmful plants, which herbicides are selected from the group consisting of the compounds (listed by the “common name” and with a literature reference, for example from “The Pesticide Manual”, 12th ed., British Crop Protection Council 2000, abbreviated “PM”, or from “The Pesticide Manual”, 10th ed., 1994, British Crop Protection Council)
   (C1) diflufenican, for example 2′,4′-difluoro-2-(α,α,α-trifluoro-m-tolyloxy)nicotinanilide, Pesticide Manual, 10th ed. 1994, pp. 335-336 (application rate generally: 10-1000 g of AS/ha, preferably 20-800 g of AS/ha; ratio of application rates (A+B):C generally=20:1-1:800, preferably 5:1-1:500),
   (C2) imazamox, comprising in particular also its esters and salts, such as the sodium salt (PM, p. 528), for example (RS)-2-(4-isopropyl-4-methyl-5-oxo-2-imidazolin-2-yl)-5-methoxymethylnicotinic acid, (application rate generally: 1-500 g of AS/ha, preferably 2-200 g of AS/ha; ratio of application rates (A+B):C generally=200:1-1:250, preferably 50:1-1:200),
   (C3) florasulam, comprising in particular also its salts, such as the sodium salt (PM, pp. 420-421), for example 2′,6′,8′-trifluoro-5-methoxy[1,2,4]triazolo[1,5-c]pyrimidine-2-sulfonanilide, (application rate generally: 1-500 g of AS/ha, preferably 1-50 g of AS/ha; ratio of application rates (A+B):C generally=2000:1-1:25, preferably 1000:1-1:5),
   (C4) halosulfuron, comprising in particular also its esters, such as halosulfuron-methyl, and its salts, such as the sodium salt (PM, pp. 497-499), for example methyl 3-chloro-5-(4,6-dimethoxypyrimidin-2-ylcarbamoylsulfamoyl)-1-methylpyrazole-4-carboxylate, (application rate generally: 1-500 g of AS/ha, preferably 5-200 g of AS/ha; ratio of application rates (A+B):C generally=200:1-1:250, preferably 100:1-1:200),
   (C5) tritosulfuron, comprising in particular also its esters and salts, such as the sodium salt (AG Chem, New Compound Review (publ. Agranova), Vol. 17, 1999, p. 24), for example N-[[[4′-methoxy-6-(trifluoromethyl)-1,3,5-triazin-2-yl]amino]carbonyl]-2-trifluoromethylbenzene-sulfonamide), (application rate generally: 1-500 g of AS/ha, preferably 5-200 g of AS/ha; ratio of application rates (A+B):C generally=200:1-1:250, preferably 100:1-1:200),
   (C6) picolinafen, comprising in particular also its salts, such as the sodium salt (PM, pp. 742-743), for example 4′-fluoro-6-[(α,α,α-trifluoro-m-tolyl)oxy]picolinanilide, (application rate generally: 1-500 g of AS/ha, preferably 5-200 g of AS/ha; ratio of application rates (A+B):C generally=200:1-1:250, preferably 100:1-1:200),
   (C7) cinidon-ethyl, comprising in particular also its salts, such as the sodium salt (PM, pp. 181-182), for example ethyl (Z)-2-chloro-3-[2-chloro-5-(1,2-cyclohex-1-enedicarboximido)phenyl]acrylate, (application rate generally: 1-500 g of AS/ha, preferably 5-200 g of AS/ha; ratio of application rates (A+B):C generally=200:1-1:250, preferably 100:1-1:200),
   (C8) mesotrione (PM, p. 602), for example 2-(4-mesyl-2-nitrobenzoyl)cyclohexane-1,3-dione, (application rate generally: 5-1000 g of AS/ha, preferably 20-600 g of AS/ha; ratio of application rates (A+B):C generally=40:1-1:250, preferably 10:1-1:150),
   (C9) metosulam, comprising in particular also its salts, such as the sodium salt (PM, pp. 640-641), for example 2′,6′-dichloro-5,7-dimethoxy-3′-methyl[1,2,4]triazolo[1,5-a]pyrimidine-2-sulfonanilide, (application rate generally: 1-500 g of AS/ha, preferably 10-300 g of AS/ha; ratio of application rates (A+B):C generally=200:1-1:250, preferably 20:1-1:300),
   (C10) clopyralid, comprising in particular also its esters and salts, such as the sodium salt (PM, pp. 193-194), for example 3,6-dichloropyridine-2-carboxylic acid, (application rate generally: 10-1000 g of AS/ha, preferably 20-800 g of AS/ha; ratio of application rates (A+B):C generally=20:1-1:800, preferably 5:1-1:500),
   (C11) flufenacet, comprising also in particular its salts, such as the sodium salt (PM, pp. 434-435), for example 4′-fluoro-N-isopropyl-2-(5-trifluoromethyl-1,3,4-thiadiazol-2-yloxy)acetanilide, (application rate generally: 50-5000 g of AS/ha, preferably 150-2000 g of AS/ha; ratio of application rates (A+B):C generally=4:1-1:500, preferably 1:1-1:1000),
   (C12) flumetsulam, comprising in particular also its salts, such as the sodium salt (PM, pp. 438-439), for example 2′,6′-difluoro-5-methyl[1,2,4]triazolo[1,5-a]pyrimidine-2-sulfonanilide, (application rate generally: 5-1000 g of AS/ha, preferably 10-600 g of AS/ha; ratio of application rates (A+B):C generally=25:1-1:250, preferably 1:1-1:200),
   (C13) flupoxam, comprising in particular also its salts, such as the sodium salt (PM, p. 999), for example 1-[4-chloro-3-(2,2,3,3,3-pentafluoropropoxymethyl)phenyl]-5-phenyl-1H-1,2,4-triazole-3-carboxamide, (application rate generally: 5-5000 g of AS/ha, preferably 20-3000 g of AS/ha; ratio of application rates (A+B):C generally=40:1-1:5000, preferably 10:1-1:5000),
   (C14) prosulfocarb, comprising in particular also its salts (PM, pp. 786-787), for example S-benzyl dipropylthiocarbamate, (application rate generally: 50-5000 g of AS/ha, preferably 200-3000 g of AS/ha; ratio of application rates (A+B):C generally=4:1-1:2500, preferably 2:1-1:2000),
   (C15) flurtamone, comprising in particular also its salts, such as the sodium salt (PM, p. 459), for example (RS)-5-methylamino-2-phenyl-4-(α,α,α-trifluoro-m-tolyl)furan-3(2H)-one, (application rate generally: 50-5000 g of AS/ha, preferably 200-3000 g of AS/ha; ratio of application rates (A+B):C generally=4:1-1:2500, preferably 2:1-1:2000),
   (C16) aclonifen, comprising in particular also its salts, such as the sodium salt (PM, pp. 14-15), for example 2-chloro-6-nitro-3-phenoxyaniline, (application rate generally: 50-5000 g of AS/ha, preferably 200-3000 g of AS/ha; ratio of application rates (A+B):C generally=4:1-1:2500, preferably 2:1-1:2000),
   (C17) fenoxaprop, also comprising fenoxaprop-P, for example (±)-2-[4-(6-chloro-1,3-benzoxazol-2-yloxy)phenoxy]propionic acid, comprising inter alia the use form as fenoxaprop-ethyl, (R)-2-[4-(6-chloro-1,3-benzoxazol-2-yloxy)phenoxy]propionic acid, comprising inter alia the most common use form fenoxaprop-P-ethyl, the compounds (C17) mentioned above being known, for example, from Pesticide Manual, 10th ed. 1994, pp. 439-441 and 441-442, (application rate generally: 10-300 g of AS/ha, preferably 15-200 g of AS/ha; ratio of application rates (A+B):C generally=20:1-1:200, preferably 15:1-1:150),
   (C18) isoproturon, for example 3-(4-isopropylphenyl)-1,1-dimethylurea, Pesticide Manual, 10th ed. 1994, pp. 611-612, (application rate generally: 50-5000 g of AS/ha, preferably 100-4000 g of AS/ha; ratio of application rates (A+B):C generally=25:1-1:2500, preferably 15:1-1:2000),
   (C19) diclofop, for example (RS)-2-[4-(2,4-dichlorophenoxy)phenoxy]-propionic acid comprising inter alia, as the most important use form, the methyl ester diclofop-methyl, Pesticide Manual, 10th ed. 1994, pp. 315-317, (application rate generally: 100-3000 g of AS/ha, preferably 200-2000 g of AS/ha; ratio of application rates (A+B):C generally=2:1-1:1500, preferably 1:1-1:1200),
   (C20) clodinafop, for example (R)-2-[4-(5-chloro-3-fluoro-2-pyridyloxy)phenoxy]propionic acid, comprising in particular also the use form as clodinafop-propargyl, Pesticide Manual, 10th ed. 1994, pp. 216-217, (application rate generally: 1-150 g of AS/ha, preferably 5-100 g of AS/ha; ratio of application rates (A+B):C generally=200:1-1:80, preferably 100:1-1:60),
   (C21) chlortoluron, for example 3-(3-chloro-p-tolyl)-1,1-dimethylurea, Pesticide Manual, 10th ed. 1994, pp. 194-196, (application rate generally: 10-5000 g of AS/ha, preferably 20-3000 g of AS/ha; ratio of application rates (A+B):C generally=20:1-1:2500, preferably 5:1-1:2000),
   (C22) methabenzthiazuron, for example 1-(1,3-benzothiazol-2-yl)-1,3-dimethylurea, Pesticide Manual, 10th ed. 1994, pp. 670-671, (application rate generally: 10-5000 g of AS/ha, preferably 20-3000 g of AS/ha; ratio of application rates (A+B):C generally=20:1-1:2500, preferably 5:1-1:2000),
   (C23) imazamethabenz, for example the reaction product containing (±)-6-(4-isopropyl-4-methyl-4-oxo-2-imidazolin-2-yl)-m-toluic acid and (±)-6-(4-isopropyl-4-methyl-4-oxo-2-imidazolin-2-yl)-toluic acid, it being in each case also possible to employ the esters, for example the methyl esters known under the name imazamethabenz-methyl, Pesticide Manual, 10th ed. 1994, pp. 582-584, (application rate generally: 10-5000 g of AS/ha, preferably 20-3000 g of AS/ha; ratio of application rates (A+B):C generally=20:1-1:2500, preferably 15:1-1:1500),
   (C24) tralkoxydim, for example 2-[1-(ethoxyimino)propyl]-3-hydroxy-5-mesitylcyclohex-2-enone, Pesticide Manual, 10th ed. 1994, pp. 995-996, (application rate generally: 10-5000 g of AS/ha, preferably 20-3000 g of AS/ha; ratio of application rates (A+B):C generally=20:1-1:2500, preferably 15:1-1:1500),
   (C25) difenzoquat, for example 1,2-dimethyl-3,5-diphenylpyrazolium, for example also as difenzoquat-metilsulfate, Pesticide Manual, 10th ed. 1994, pp. 330-331, (application rate generally: 10-5000 g of AS/ha, preferably 20-3000 g of AS/ha; ratio of application rates (A+B):C generally=20:1-1:2500, preferably 5:1-1:2000),
   (C26) flamprop, also comprising flamprop-M, for example N-benzoyl-N-(3-chloro-4-fluorophenyl)-DL-alanine and N-benzoyl-N-(3-chloro-4-fluorophenyl)-D-alanine, comprising inter alia also flamprop-methyl, flamprop-M-methyl, flamprop-M-isopropyl, Pesticide Manual, 10th ed. 1994, pp. 464-465 and 466-468, (application rate generally: 10-5000 g of AS/ha, preferably 20-3000 g of AS/ha; ratio of application rates (A+B):C generally=20:1-1:2500, preferably 5:1-1:2000),
   (C27) pendimethalin, for example N-(1-ethylpropyl)-2,6-dinitro-3,4-xylidine, Pesticide Manual, 10th ed. 1994, pp. 779-780, (application rate generally: 50-5000 g of AS/ha, preferably 100-3000 g of AS/ha; ratio of application rates (A+B):C generally=3:1-1:2500, preferably 1:1-1:2000),
   (C28) mecoprop, also comprising mecoprop-P, for example (RS)-2-(4-chloro-o-tolyloxy)propionic acid and (R)-2-(4-chloro-o-tolyloxy)propionic acid, Pesticide Manual, 10th ed. 1994, pp. 646-647 and 647-648, (application rate generally: 10-5000 g of AS/ha, preferably 20-3000 g of AS/ha; ratio of application rates (A+B):C generally=20:1-1:2500, preferably 5:1-1:2000),
   (C29) MCPA, for example (4-chloro-2-methylphenoxy)acetic acid, the most frequently used forms are inter alia, for example, MCPA-butotyl, MCPA-dimethylammonium, MCPA-isooctyl, MCPA-potassium, MCPA-sodium, Pesticide Manual, 10th ed. 1994, pp. 638-640, (application rate generally: 10-5000 g of AS/ha, preferably 20-3000 g of AS/ha; ratio of application rates (A+B):C generally=20:1-1:2500, preferably 5:1-1:2000),
   (C30) dichlorprop, also comprising dichlorprop-P, for example (RS)-2-(2,4-dichlorophenoxy)propionic acid and (R)-2-(2,4-dichlorophenoxy)-propionic acid, also used are inter alia dichlorprop-butotyl, dichlorprop-ethylammonium, dichlorprop-isooctyl, dichlorprop-potassium, Pesticide Manual, 10th ed. 1994, pp. 309-311 and 311-312, (application rate generally: 10-5000 g of AS/ha, preferably 20-3000 g of AS/ha; ratio of application rates (A+B):C generally=20:1-1:2500, preferably 5:1-1:2000),
   (C31) 2,4-D, for example (2,4-dichlorophenoxy)acetic acid, frequently used forms are: 2,4-D-butotyl, 2,4-D-butyl, 2,4-D-dimethylammonium, 2,4-D-diolamine, 2,4-D-isooctyl, 2,4-D-isopropyl, 2,4-D-trolamine, Pesticide Manual, 10th ed. 1994, pp. 271-273, (application rate generally: 10-5000 g of AS/ha, preferably 20-3000 g of AS/ha; ratio of application rates (A+B):C generally=20:1-1:2500, preferably 5:1-1:2000),
   (C32) dicamba, for example 3,6-dichloro-o-anisic acid, used inter alia as dicamba-dimethylammonium, dicamba-potassium, dicamba-sodium, dicamba-trolamine, Pesticide Manual, 10th ed. 1994, pp. 298-300, (application rate generally: 20-500 g of AS/ha, preferably 30-400 g of AS/ha; ratio of application rates (A+B):C generally=10:1-1:250, preferably 4:1-1:200),
   (C33) fluroxypyr, for example 4-amino-3,5-dichloro-6-fluoro-2-pyridyloxyacetic acid, further use form: fluoroxypyr-meptyl, and also, particularly preferably: fluroxypyr-butoxypropyl ester, Pesticide Manual, 10th ed. 1994, pp. 505-507, (application rate generally: 20-500 g of AS/ha, preferably 30-400 g of AS/ha; ratio of application rates (A+B):C generally=10:1-1:250, preferably 4:1-1:200),
   (C34) ioxynil, for example 4-hydroxy-3,5-diiodobenzonitrile, common use forms: ioxynil-octanoate, ioxynil-sodium, Pesticide Manual, 10th ed. 1994, pp. 598-600, (application rate generally: 10-3000 g of AS/ha, preferably 50-1500 g of AS/ha; ratio of application rates (A+B):C generally=20:1-1:1500, preferably 2:1-1:1200),
   (C35) bromoxynil, for example 3,5-dibromo-4-hydroxybenzonitrile, frequently as bromoxynil-octanoate, bromoxynil-potassium, Pesticide Manual, 10th ed. 1994, pp. 121-123, (application rate generally: 10-3000 g of AS/ha, preferably 50-1500 g of AS/ha; ratio of application rates (A+B):C generally=20:1-1:1500, preferably 2:1-1:1200),
   (C36) bifenox, for example methyl 5-(2,4-dichlorophenoxy)-2-nitrobenzoate, Pesticide Manual, 10th ed. 1994, pp. 94-96, (application rate generally: 50-5000 g of AS/ha, preferably 100-4000 g of AS/ha; ratio of application rates (A+B):C generally=4:1-1:2500, preferably 1:1-1:2000),
   (C37) fluoroglycofen, for example O-[5-(2-chloro-α,α,α-trifluor-p-tolyloxy)-2-nitrobenzoyl]glycolic acid, further use form: fluoroglycofen-ethyl, Pesticide Manual, 10th ed. 1994, pp. 492-494, (application rate generally: 1-200 g of AS/ha, preferably 2-150 g of AS/ha; ratio of application rates (A+B):C generally=200:1-1:150, preferably 50:1-1:100),
   (C38) lactofen, for example ethyl O-[5-(2-chloro-α,α,α-trifluoro-p-tolyloxy)-2-nitrobenzoyl]-DL-lactate, Pesticide Manual, 10th ed. 1994, p. 623, (application rate generally: 5-1000 g of AS/ha, preferably 10-500 g of AS/ha; ratio of application rates (A+B):C generally=40:1-1:500, preferably 10:1-1:400),
   (C39) pyraflufen, also comprising pyraflufen-ethyl (ET 751), for example ethyl 2-chloro-5-(4-chloro-5-difluoromethoxy-1-methylpyrazol-3-yl)-4-fluorophenoxyacetate, (PM pp. 792-793), (application rate generally: 1-50 g of AS/ha, preferably 2-40 g of AS/ha; ratio of application rates (A+B):C generally=200:1-1:400, preferably 50:1-1:300),
   (C40) flucarbazone, comprising in particular also its salts, such as the sodium salt (PM, pp. 427-428), for example 4,5-dihydro-3-methoxy-4-methyl-5-oxo-N-(2-trifluoromethoxyphenylsulfonyl)-1H-1,2,4-triazole-1-carboxamide sodium salt, (application rate generally: 1-500 g of AS/ha, preferably 5-200 g of AS/ha; ratio of application rates (A+B):C generally=200:1-1:50, preferably 40:1-1:100),
   (C41) bentazone, for example 3-isopropyl-1H-2,1,3-benzothiadiazin-4(3H)-one 2,2-dioxide, Pesticide Manual, 10th ed. 1994, pp. 90-91, (application rate generally: 50-5000 g of AS/ha, preferably 100-3000 g of AS/ha; ratio of application rates (A+B):C generally 4:1-1:3000, preferably 1:1-1:2500),
   (C42) amidosulfuron, for example 1-(4,6-dimethoxypyrimidin-2-yl)-3-mesyl(methyl)sulfamoylurea, Pesticide Manual, 10th ed. 1994, pp. 34-35, (application rate generally: 0.5-200 g of AS/ha, preferably 1-100 g of AS/ha; ratio of application rates (A+B):C generally=400:1-1:100, preferably 100:1-1:60),
   (C43) metsulfuron, for example 2-(4-methoxy-6-methyl-1,3,5-triazin-2-ylcarbamoylsulfamoyl)benzoic acid, usually employed as metsulfuron-methyl, Pesticide Manual, 10th ed. 1994, pp. 701-702, (application rate generally: 0.5-120 g of AS/ha, preferably 1-100 g of AS/ha; ratio of application rates (A+B):C generally=400:1-1:100, preferably 100:1-1:60),
   (C44) tribenuron, for example 2-[4-methoxy-6-methyl-1,3,5-triazin-2-yl(methyl)carbamoylsulfamoyl]benzoic acid, usually employed as tribenuron-methyl, Pesticide Manual, 10th ed. 1994, pp. 1010-1011, (application rate generally: 0.5-120 g of AS/ha, preferably 1-100 g of AS/ha; ratio of application rates (A+B):C generally=400:1-1:100, preferably 100:1-1:60),
   (C45) thifensulfuron, for example 3-(4-methoxy-6-methyl-1,3,5-triazin-2-ylcarbamoylsulfamoyl)thiophene-2-carboxylic acid, most commonly used as thifensulfuron-methyl, Pesticide Manual, 10th ed. 1994, pp. 976-978, (application rate generally: 0.5-120 g of AS/ha, preferably 1-100 g of AS/ha; ratio of application rates (A+B):C generally=400:1-1:100, preferably 100:1-1:60),
   (C46) triasulfuron, for example 1-[2-(2-chloroethoxy)phenylsulfonyl]-3-(4-methoxy-6-methyl-1,3,5-triazin-2-yl)urea, Pesticide Manual, 10th ed. 1994, pp. 1005-1006, (application rate generally: 0.5-120 g of AS/ha, preferably 1-100 g of AS/ha; ratio of application rates (A+B):C generally=400:1-1:100, preferably 100:1-1:60),
   (C47) chlorsulfuron, for example 1-(2-chlorophenylsulfonyl)-3-(4-methoxy-6-methyl-1,3,5-triazin-2-yl)urea, Pesticide Manual, 10th ed. 1994, pp. 203-205, (application rate generally: 1-150 g of AS/ha, preferably 2-120 g of AS/ha; ratio of application rates (A+B):C generally=200:1-1:150, preferably 50:1-1:60),
   (C48) flupyrsulfuron (DPX-KE459), for example methyl 2-(4,6-dimethoxypyrimidin-2-ylcarbamoylsulfamoyl)-6-trifluoromethyl-nicotinate, for example flupyrsulfuron-methyl-sodium (PM, pp. 447-448), (application rate generally: 1-120 g of AS/ha, preferably 2-100 g of AS/ha; ratio of application rates (A+B):C generally=200:1-1:120, preferably 50:1-1:50),
   (C49) fluazolate (MON 48500), for example isopropyl 5-(4-bromo-1-methyl-5-trifluoromethylpyrazol-3-yl)-2-chloro-4-fluorobenzoate, preferably as sodium salt, (PM, pp. 425-426), (application rate generally: 1-120 g of AS/ha, preferably 2-100 g of AS/ha; ratio of application rates (A+B):C generally 100:1-1:60, preferably 50:1-1:30),
   (C50) sulfosulfuron (MON37500), for example 1-(4,6-dimethoxypyrimidin-2-yl)-3-(2-ethylsulfonylimidazo[1,2-a]pyridin-3-yl)sulfonylurea, (PM, pp. 853-854), (application rate generally: 1-120 g of AS/ha, preferably 2-100 g of AS/ha; ratio of application rates (A+B):C generally=200:1-1:120, preferably 50:1-1:50),
   (C51) glufosinate, also comprising glufosinate-P, for example 4-[hydroxy(methyl)phosphinoyl]-DL-homoalanine, 4-[hydroxy(methyl) phosphinoyl]-L-homoalanine, each of which is preferably used as a salt, for example in ammonium or alkali metal salts, such as glufosinate-ammonium, glufosinate-P-ammonium, glufosinate-sodium or glufosinate-P-sodium, Pesticide Manual, 10th ed. 1994, pp. 541-542, (application rate generally: 50-5000 g of AS/ha, preferably 100-2000 g of AS/ha; ratio of application rates (A+B):C generally=5:1-1:5000, preferably 1:1-1:1000),
   (C52) glyphosate, for example N-(phosphonomethyl)glycine, which is preferably used as glyphosate-isopropylammonium, glyphosate-sesquisodium, glyphosate-trimesium, Pesticide Manual, 10th ed. 1994, pp. 542-544, (application rate generally: 50-5000 g of AS/ha, preferably 100-2000 g of AS/ha; ratio of application rates (A+B):C generally=5:1-1:5000, preferably 1:1-1:1000),
   (C53) sulcotrione (ICIA0051), for example 2-[2-chloro-4-(methylsulfonyl)-benzoyl]-1,3-cyclohexanedione, Pesticide Manual, 10th ed. 1994, pp. 577-578, (application rate generally: 50-1500 g of AS/ha, preferably 100-1000 g of AS/ha; ratio of application rates (A+B):C generally=4:1-1:1500, preferably 1:1-1:500),
   (C54) cycloxydim, for example (±)-2-[1-(ethoxyimino)butyl]-3-hydroxy-5-thian-3-ylcyclohex-2-enone, (PM, pp. 218-219), (application rate generally: 5-2000 g of AS/ha, preferably 8-1000 g of AS/ha; ratio of application rates (A+B):C generally=40:1-1:2000, preferably 20:1-1:500),
   (C55) sethoxydim, for example (±)-(EZ)-2-(1-ethoxyiminobutyl)-5-[2-(ethylthio)propyl]-3-hydroxycyclohex-2-enone, (PM, pp. 832-833), (application rate generally: 5-2000 g of AS/ha, preferably 8-1000 g of AS/ha; ratio of application rates (A+B):C generally=40:1-1:2000, preferably 20:1-1:500),
   (C56) clethodim, for example (±)-2-[(E)-1-[(E)-3-chloroalkyloxyimino]propyl]-5-[2-(ethylthio)propyl]-3-hydroxycyclohex-2-enone, (PM, pp. 185-186), (application rate generally: 5-2000 g of AS/ha, preferably 8-1000 g of AS/ha; ratio of application rates (A+B):C generally=40:1-1:2000, preferably 20:1-1:500),
   (C57) carfentrazone, for example ethyl (RS)-2-chloro-3-[2-chloro-5-(4-difluoromethyl-4,5-dihydro-3-methyl-5-oxo-1H-1,2,4-triazol-1-yl)-4-fluorophenyl]propionate, used inter alia as carfentrazone-ethyl (as shown) or else as acid, (PM, pp. 141-142), (application rate generally: 1-80 g of AS/ha, preferably 2-60 g of AS/ha; ratio of application rates (A+B):C generally=200:1-1:80, preferably 50:1-1:30),
   (C58) imazethapyr, comprising in particular also its esters and salts, such as the sodium salt (PM, pp. 533-534), for example (RS)-5-ethyl-2-(4-isopropyl-4-methyl-5-oxo-2-imidazolin-2-yl)nicotinic acid, (application rate generally: 1-500 g of AS/ha, preferably 2-300 g of AS/ha; ratio of application rates (A+B):C generally=200:1-1:500, preferably 50:1-1:150),
   (C59) imazaquin, comprising in particular also its esters and salts, such as the sodium salt (PM, pp. 531-533), for example (RS)-2-(4-isopropyl-4-methyl-5-oxo-2-imidazolin-2-yl)quinoline-3-carboxylic acid, (application rate generally: 1-500 g of AS/ha, preferably 2-300 g of AS/ha; ratio of application rates (A+B):C generally=200:1-1:500, preferably 50:1-1:150),
   (C60) imazapyr, comprising in particular also its esters and salts, such as the sodium salt (PM, pp. 530-531), for example 2-(4-isopropyl-4-methyl-5-oxo-2-imidazolin-2-yl)nicotinic acid, (application rate generally: 1-500 g of AS/ha, preferably 2-300 g of AS/ha; ratio of application rates (A+B):C generally=200:1-1:500, preferably 50:1-1:150),
   (C61) imazapic, comprising in particular also its esters and salts, such as the sodium salt (PM, pp. 529), for example (RS)-2-(4-isopropyl-4-methyl-5-oxo-2-imidazolin-2-yl)-5-methylnicotinic acid, (application rate generally: 1-500 g of AS/ha, preferably 2-300 g of AS/ha; ratio of application rates (A+B):C generally=200:1-1:500, preferably 50:1-1:150),
   (C62) beflubutamid, for example N-benzyl-2-(α,α,α-4-tetrafluoro-m-tolyloxy)butyramide (PM, pp. 63), (application rate generally: 10-1000 g of AS/ha, preferably 20-800 g of AS/ha; ratio of application rates (A+B):C generally=20:1-1:2000, preferably 5:1-1:800),
   (C63) fentrazamide, for example 4-(2-chlorophenyl)-N-cyclohexyl-N-ethyl-4,5-dihydro-5-oxo-1H-tetrazol-1-carboxamide (PM, pp. 406-407), (application rate generally: 10-1000 g of AS/ha, preferably 20-800 g of AS/ha; ratio of application rates (A+B):C generally=20:1-1:2000, preferably 5:1-1:800),
   (C64) flufenacet, for example 4′-fluoro-N-isopropyl-2-(5-trifluoromethyl-1,3,4-thiadiazol-2-yloxy)acetanilide (PM, pp. 434-435), (application rate generally: 10-1000 g of AS/ha, preferably 20-800 g of AS/ha; ratio of application rates (A+B):C generally=20:1-1:2000, preferably 5:1-1:800),
   (C65) amicarbazone, for example 4-amino-N-tert-butyl-4,5-dihydro-3-isopropyl-5-oxo-1H-1,2,4-triazole-1-carboxamide (PM, pp. 28-29), (application rate generally: 10-1000 g of AS/ha, preferably 20-800 g of AS/ha; ratio of application rates (A+B):C generally=20:1-1:2000, preferably 5:1-1:800).

If, in the context of this description, the short form of the “common name” of an active compound is used, this comprises in each case all customary derivatives, such as the esters and salts, and isomers, in particular optical isomers, especially the commercially available form or forms. If the “common name” refers to an ester or a salt, this in each case also comprises all other customary derivatives, such as other esters and salts, the free acids and neutral compounds, and isomers,: in particular optical isomers, especially the commercially available form or forms. The given chemical compound names refer to at least one of the compounds embraced by the “common name”, frequently to a preferred compound. In the case of sulfonamides such as sulfonylureas, salts also include salts formed by exchanging a hydrogen atom of the sulfonamide group for a cation.

When using the herbicide combinations according to the invention, the herbicides C1, C2, C4, C8, C9, C11-C16, C18, C21, C22, C23, C24, C27, C40, C43, C47-C53, C58-C61, C63-C65 are particularly suitable for controlling monocotyledonous and dicotyledonous harmful plants, the herbicides C17, C19, C20, C25, C26, C54-C56 are particularly suitable for controlling monocotyledonous harmful plants and the herbicides C3, C5, C6, C7, C10, C28-C39, C41, C42, C44, C45, C46, C57, C62 are particularly suitable for controlling dicotyledonous harmful plants.

The herbicide combinations according to the invention have a herbicidally effective content of components (A), (B) and (C) and may comprise further components, for example agrochemically active compounds of different type and/or additives customary in crop protection and/or formulation auxiliaries, or may be used together with these compounds. Preference is given to herbicide combinations having a synergistically effective content of components (A), (B) and (C).

In a preferred embodiment, the herbicide combinations according to the invention have synergistic actions. The synergistic actions can be observed,for example, when the active compounds (A), (B) and (C) are applied together; however, they can frequently also be observed when the active compounds are applied at different times (splitting). It is also possible to apply the individual herbicides or the herbicide combinations in a plurality of portions (sequential application), for example pre-emergence applications followed by post-emergence applications or early post-emergence applications followed by medium or late post-emergence applications. Preference is given here to the joint or almost simultaneous application of the active compounds of the herbicide combinations according to the invention.

The synergistic effects permit a reduction of the application rates of the individual active compounds, a higher efficacy at the same application rate, the control of species which were as yet uncontrolled (gaps), an extension of the period of application and/or a reduction in the number of individual applications required and—as a result for the user—, weed control systems which are more advantageous economically and ecologically.

The formulae (I) and (II) mentioned embrace all stereoisomers and their mixtures, in particular also racemic mixtures, and—if enantiomers are possible—in each case the biologically active enantiomers. Compounds of the formulae (I) and (II) and their salts and also their preparation are described, for example, in U.S. Pat. No. 5,534,486 and WO 95/10507. Preferred compounds of the formula (I) and their salts are methyl 2-[3-(4,6-dimethoxypyrimidin-2-yl)ureidosulfonyl]-4-methanesulfonaminomethyl-benzoate (mesosulfuron-methyl, A1) and its salts, such as the sodium salt (mesosulfuron-methyl sodium, A2) (see, for example, WO 95/10507 and Agrow No. 347, 3.3.2000, page 22 (PJB Publications Ltd. 2000)). Preferred compounds of the formula (II) and their salts are methyl 2-({[(4-methyl-5-oxo-3-propoxy-4,5-dihydro-1H-1,2,4-triazol-1-yl)carbonyl]amino}sulfonyl)benzoate (propoxycarbazone, B1) and its salts, such as the sodium salt (propoxycarbazone-sodium, B2) (see, for example, U.S. Pat. No. 5,534,486 and Z. PflKrankh. PflSchutz, special issue XVII, 545-553 (2000)).

The active compounds of the formulae (I) and (II) mentioned and their salts are capable of inhibiting the enzyme acetolactate synthase (ALS) and thus protein synthesis in plants. The application rate of the active compounds of the formulae (I) and (II) and their salts can vary within wide ranges, for example between 0.001 and 0.5 kg of AS/ha. Whenever the abbreviation AS/ha is used in the present description, this is to be understood as meaning “active substance per hectare”, based on 100% pure active compound. Applications with application rates of from 0.01 to 0.3 kg of AS/ha of the active compounds of the formulae (I) and (II) and their salts, preferably of the active compounds (A1), (A2), (B1) and (B2), by the pre- and post-emergence method allows the control of a relatively wide spectrum of annual and perennial broad-leaved weeds, weed grasses and Cyperaceae. In the combinations according to the invention, the application rates are generally lower, for example in the range from 0.1 to 200 g of AS/ha, preferably from 0.5 to 150 g of AS/ha.

The active compounds can be formulated, for example, as a wettable powder (WP), as water-dispersible granules (WDG), as water-emulsifiable granules (WEG), as a suspoemulsion (SE) or as an oil dispersion concentrate (for example an oil suspension concentrate) (OD).

The ratios of application rates (A+B):C which are generally used are stated above and refer to the ratio by weight of components (A+B) to C. The ratio by weight of components A to B is generally 1:100-60:1, preferably 1:80-40:1.

When using the active compounds of the formulae (I) and (II) and their salts in crop plants, it may be expedient, depending on the crop plant, to apply a safener above certain application rates to reduce or avoid damage to the crop plant. Examples of suitable safeners are those which act as safeners in combination with sulfonamide herbicides, preferably phenylsulfonamides. Suitable safeners are known, for example, from WO-A-96/14747 and the literature cited therein.

The following groups of compounds are, for example, suitable as safeners for the herbicidally active compounds (A) and (B) mentioned above:
a) compounds of the type of the dichlorophenylpyrazoline-3-carboxylic acid (S1), preferably compounds such as ethyl 1-(2,4-dichlorophenyl)-5-(ethoxycarbonyl)-5-methyl-2-pyrazoline-3-carboxylate (S1-1, mefenpyr-diethyl, PM, pp. 594-595), and related compounds, as described, for example, in WO 91/07874 and PM (pp.594-595).
b) Derivatives of dichlorophenylpyrazolecarboxylic acid, preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4), ethyl 1-(2,4-dichlorophenyl)-5-phenylpyrazole-3-carboxylate (S1-5) and related compounds, as described in EP-A-333 131 and EP-A-269 806.
c) Compounds of the type of the triazolecarboxylic acids (S1), preferably compounds such as fenchlorazole, i.e. ethyl 1-(2,4-dichlorophenyl)-5-trichloromethyl-(1H)-1,2,4-triazole-3-carboxylate (S1-6), and related compounds (see EP-A-174 562 and EP-A-346 620).
d) Compounds of the type of the 5-benzyl- or 5-phenyl-2-isoxazoline-3-carboxylic acid or the 5,5-diphenyl-2-isoxazoline-3-carboxylic acid, preferably compounds such as ethyl 5-(2,4-dichlorobenzyl)-2-isoxazoline-3-carboxylate (S1-7) or ethyl 5-phenyl-2-isoxazoline3-carboxylate (S1-8) and related compounds, as described, for example, in WO 91/08202, or of 5,5-diphenyl-2-isoxazoline-3-carboxylic acid and its ethyl ester (S1-9, isoxadifen-ethyl) or its n-propyl ester (S1-10) or of ethyl 5-(4-fluorophenyl)-5-phenyl-2-isoxazoline-3-carboxylate (S1-11), as described in the patent application (WO-A-95/07897).
e) Compounds of the type of the 8-quinolinoxyacetic acid (S2), preferably 1-methylhex-1-yl (5-chloro-8-quinolinoxy)acetate (S2-1, cloquintocet-mexyl, for example PM, pp. 195-196), 1,3-dimethylbut-1-yl (5-chloro-8-quinolinoxy)-acetate (S2-2), 4-allyloxybutyl (5-chloro-8-quinolinoxy)acetate (S2-3), 1-allyloxyprop-2-yl (5-chloro-8-quinolinoxy)acetate (S2-4), ethyl (5-chloro-8-quinolinoxy)acetate (S2-5), methyl (5-chloro-8-quinolinoxy)acetate (S2-6), allyl (5-chloro-8-quinolinoxy)acetate (S2-7), 2-(2-propylideneiminoxy)-1-ethyl (5-chloro-8-quinolinoxy)acetate (S2-8), 2-oxoprop-1-yl (5-chloro-8-quinolinoxy)acetate (S2-9) and related compounds, as described in EP-A-86 750, EP-A-94 349 and EP-A-191 736 or EP-A-0 492 366.
f) Compounds of the type of the (5-chloro-8-quinolinoxy)malonic acid, preferably compounds such as diethyl (5-chloro-8-quinolinoxy)malonate, dialllyl (5-chloro-8-quinolinoxy)malonate, methyl ethyl (5-chloro-8-quinolinoxy)malonate and related compounds, as described in EP-A-0 582 198.
g) Active compounds of the type of the phenoxyacetic or -propionic acid derivatives or the aromatic carboxylic acids, such as, for example, 2,4-dichlorophenoxyacetic acid (esters) (2,4-D), 4-chloro-2-methylphenoxy-propionic esters (mecoprop), MCPA or 3,6-dichloro-2-methoxybenzoic acid (esters) (dicamba).

The abovementioned safeners are in many cases also suitable for active compounds of group (C). Moreover, the following safeners are suitable for the herbicide combinations according to the invention:
h) active compounds of the type of the pyrimidines, such as “fenclorim” (PM, pp. 386-387)(=4,6-dichloro-2-phenylpyrimidine),
i) active compounds of the type of the dichloracetamides, which are frequently used as pre-emergence safeners (soil-acting safeners), such as, for example,
   “dichlormid” (PM, pp. 270-271) (═N,N-diallyl-2,2-dichloroacetamide),
   “R-29148” (=3-dichloroacetyl-2,2,5-trimethyl-1,3-oxazolidone from Stauffer),
   “Benoxacor” (PM, pp. 74-75) (=4-dichloroacetyl-3,4-dihydro-3-methyl-2H-1,4-benzoxazine),
   “APPG-1292” (═N-allyl-N-[(1,3-dioxolan-2-yl)methyl]dichloroacetamide from PPG Industries),
   “DK-24” (═N-allyl-N-[(allylaminocarbonyl)methyl]dichloroacetamide from Sagro-Chem),
   “AD-67” or “MON 4660” (=3-dichloroacetyl-1-oxa-3-azaspiro[4,5]decane from Nitrokemia or Monsanto),
   “Diclonon” or “BAS145138” or “LAB145138” (=3-dichloroacetyl-2,5,5-trimethyl-1,3-diazabicyclo[4.3.0]nonane from BASF) and
   “Furilazole” or “MON 13900” (see PM, pp. 482-483) (═(RS)-3-dichloroacetyl-5-(2-furyl)-2,2-dimethyloxazolidone),
j) active compounds of the type of the dichloroacetone derivatives, such as, for example,
   “MG 191” (CAS-Reg. No. 96420-72-3) (=2-dichloromethyl-2-methyl-1,3-dioxolane from Nitrokemia),
k) active compounds of the type of the oxyimino compounds, which are known as seed dressings, such as, for example,
   “Oxabetrinil” (PM, pp. 689) (=(Z)-1,3-dioxolan-2-ylmethoxyimino(phenyl)-acetonitrile), which is known as a seed dressing safener against damage caused by metolachlor,
   “Fluxofenim” (PM, pp. 467-468) (=1-(4-chlorophenyl)-2,2,2-trifluoro-1-ethanone-O-(1,3-dioxolan-2-ylmethyl oxime), which is known as a seed dressing safene against damage caused by metolachlor, and
   “Cyometrinil” or “CGA-43089” (PM, pp. 983) (=(Z)-cyanomethoxyimino (phenyl)acetonitrile), which is known as a seed dressing safener against damage caused by metolachlor,
l) active compounds of the type of the thiazolecarboxylic acid esters, which are known as seed dressings, such as, for example,
   “Flurazole” (PM, pp. 450-451) (=benzyl 2-chloro-4-trifluoromethyl-1,3-thiazole-5-carboxylate), which is known as a seed dressing safener against damage caused by alachlor and metolachlor,
m) active compounds of the type of the napthalenedicarboxylic acid derivatives, which are known as seed dressings, such as, for example,
   “Naphthalic anhydride” (PM, pp. 1009-1010) (=1,8-naphthalenedicarboxylic anhydride), which is known as a seed dressing safener for corn against damage caused by thiocarbamate herbicides,
n) active compounds of the type of the chromanacetic acid derivatives, such as, for example,
   “CL 304415” (CAS-Reg. No. 31541-57-8) (=2-(4-carboxychroman-4-yl)-acetic acid from American Cyanamid),
o) active compounds which, in addition to a herbicidal action against harmful plants, also have safener action in crop plants, such as, for example,
   “Dimepiperate” or “MY-93” (PM, pp. 302-303) (═S-1-methyl-1-phenylethyl piperidine-1-thiocarboxylate),
   “Daimuron” or “SK 23” (PM, pp. 247) (=1-(1-methyl-1-phenylethyl)-3-p-tolyl-urea),
   “Cumyluron”=“JC-940” (=3-(2-chlorophenylmethyl)-1-(1-methyl-1-phenyl-ethyl)urea, see JP-A-60087254),
   “Methoxyphenone” or “NK 049” (=3,3′-dimethyl-4-methoxy-benzophenone),
   “CSB” (=1-bromo-4-(chloromethylsulfonyl)benzene) (CAS-Reg. No. 54091-06-4 from Kumiai).

The herbicides (A) and (B) are, if appropriate in the presence of safeners, suitable for controlling harmful plants in crop plants, for example in economically important crops, such -as cereals (for example wheat, barley, rye, oats, rice, corn, millet), sugar beet, sugar cane, oilseed rape, cotton and soybeans. Of particular interest here is the use in monocotyledonous crops such as cereals, in particular wheat, barley, rye, oats, crossbreeds thereof, such as triticale, rice, corn and millet. These crops are also preferred for the combinations (A)+(B)+(C).

The invention also embraces herbicide combinations which, in addition to components (A), (B) and (C), also contain one or more further agrochemically active compounds of a different structure, such as herbicides, insecticides, fungicides or safeners. The preferred conditions outlined in particular for combinations (A)+(B)+(C) according to the invention also apply primarily to these combinations if they contain the combinations (A)+(B1)+(C) according to the invention, with respect to the combination (A)+(B1)+(C) in question. Of particular interest are herbicide combinations having a content of the following compounds (A)+(B1)+(C):

(A1)+(B1)+(C1), (A1)+(B1)+(C2), (A1)+(B1)+(C3), (A1)+(B1)+(C4), (A1)+(B1)+(C5), (A1)+(B1)+(C6), (A1)+(B1)+(C7), (A1)+(B1)+(C8), (A1)+(B1)+(C9), (A1)+(B1)+(C10), (A1)+(B1)+(C11), (A1)+(B1)+(C12), (A1)+(B1)+(C13), (A1)+(B1)+(C14), (A1)+(B1)+(C15), (A1)+(B1)+(C16), (A1)+(B1)+(C17), (A1)+(B1)+(C18), (A1)+(B1)+(C19), (A1)+(B1)+(C20), (A1)+(B1)+(C21), (A1)+(B1)+(C22), (A1)+(B1)+(C23), (A1)+(B1)+(C24), (A1)+(B1)+(C25), (A1)+(B1)+(C26), (A1)+(B1)+(C27), (A1)+(B1)+(C28), (A1)+(B1)+(C29), (A1)+(B1)+(C30), (A1)+(B1)+(C31), (A1)+(B1)+(C32), (A1)+(B1)+(C33), (A1)+(B1)+(C34), (A1)+(B1)+(C35), (A1)+(B1)+(C36), (A1)+(B1)+(C37), (A1)+(B1)+(C38), (A1)+(B1)+(C39), (A1)+(B1)+(C40), (A1)+(B1)+(C41), (A1)+(B1)+(C42), (A1)+(B1)+(C43), (A1)+(B1)+(C44), (A1)+(B1)+(C45), (A1)+(B1)+(C46), (A1)+(B1)+(C47), (A1)+(B1)+(C48), (A1)+(B1)+(C49), (A1)+(B1)+(C50), (A1)+(B1)+(C51), (A1)+(B1)+(C52), (A1)+(B1)+(C53), (A1)+(B1)+(C54), (A1)+(B1)+(C55), (A1)+(B1)+(C56), (A1)+(B1)+(C57), (A1)+(B1)+(C58), (A1)+(B1)+(C59), (A1)+(B1)+(C60), (A1)+(B1)+(C61), (A1)+(B1)+(C62), (A1)+(B1)+(C63), (A1)+(B1)+(C64), (A1)+(B1)+(C65);

(A1)+(B2)+(C1), (A1)+(B2)+(C2), (A1)+(B2)+(C3), (A1)+(B2)+(C4), (A1)+(B2)+(C5), (A1)+(B2)+(C6), (A1)+(B2)+(C7), (A1)+(B2)+(C8), (A1)+(B2)+(C9), (A1)+(B2)+(C10), (A1)+(B2)+(C11), (A1)+(B2)+(C12), (A1)+(B2)+(C13), (A1)+(B2)+(C14), (A1)+(B2)+(C15), (A1)+(B2)+(C16), (A1)+(B2)+(C17), (A1)+(B2)+(C18), (A1)+(B2)+(C19), (A1)+(B2)+(C20), (A1)+(B2)+(C21), (A1)+(B2)+(C22), (A1)+(B2)+(C23), (A1)+(B2)+(C24), (A1)+(B2)+(C25), (A1)+(B2)+(C26), (A1)+(B2)+(C27), (A1)+(B2)+(C28), (A1)+(B2)+(C29), (A1)+(B2)+(C30), (A1)+(B2)+(C31), (A1)+(B2)+(C32), (A1)+(B2)+(C33), (A1)+(B2)+(C34), (A1)+(B2)+(C35), (A1)+(B2)+(C36), (A1)+(B2)+(C37), (A1)+(B2)+(C38), (A1)+(B2)+(C39), (A1)+(B2)+(C40), (A1)+(B2)+(C41), (A1)+(B2)+(C42), (A1)+(B2)+(C43), (A1)+(B2)+(C44), (A1)+(B2)+(C45), (A1)+(B2)+(C46), (A1)+(B2)+(C47), (A1)+(B2)+(C48), (A1)+(B2)+(C49), (A1)+(B2)+(C50), (A1)+(B2)+(C51), (A1)+(B2)+(C52), (A1)+(B2)+(C53), (A1)+(B2)+(C54), (A1)+(B2)+(C55), (A1)+(B2)+(C56), (A1)+(B2)+(C57), (A1)+(B2)+(C58), (A1)+(B2)+(C59), (A1)+(B2)+(C60), (A1)+(B2)+(C61), (A1)+(B2)+(C62), (A1)+(B2)+(C63), (A1)+(B2)+(C64), (A1)+(B2)+(C65);

(A2)+(B1)+(C1), (A2)+(B1)+(C2), (A2)+(B1)+(C3), (A 2)+(B1)+(C4), (A2)+(B1)+(C5), (A2)+(B1)+(C6), (A2)+(B1)+(C7), (A2)+(B1)+(C8), (A2)+(B1)+(C9), (A2)+(B1)+(C10), (A2)+(B1)+(C11), (A2)+(B1)+(C12), (A2)+(B1)+(C13), (A2)+(B1)+(C14), (A2)+(B1)+(C15), (A2)+(B1)+(C16), (A2)+(B1)+(C17), (A2)+(B1)+(C18), (A2)+(B1)+(C19), (A2)+(B1)+(C20), (A2)+(B1)+(C21), (A2)+(B1)+(C22), (A2)+(B1)+(C23), (A2)+(B1)+(C24), (A2)+(B1)+(C25), (A2)+(B1)+(C26), (A2)+(B1)+(C27), (A2)+(B1)+(C28), (A2)+(B1)+(C29), (A2)+(B1)+(C30), (A2)+(B1)+(C31), (A2)+(B1)+(C32), (A2)+(B1)+(C33), (A2)+(B1)+(C34), (A2)+(B1)+(C35), (A2)+(B1)+(C36), (A2)+(B1)+(C37), (A2)+(B1)+(C38), (A2)+(B1)+(C39), (A2)+(B1)+(C40), (A2)+(B1)+(C41), (A2)+(B1)+(C42), (A2)+(B1)+(C43), (A2)+(B1)+(C44), (A2)+(B1)+(C45), (A2)+(B1)+(C46); (A2)+(B1)+(C47), (A2)+(B1)+(C48), (A2)+(B1)+(C49), (A2)+(B1)+(C50), (A2)+(B1)+(C51), (A2)+(B1)+(C52), (A2)+(B1)+(C53), (A2)+(B1)+(C54), (A2)+(B1)+(C55), (A2)+(B1)+(C56), (A2)+(B1)+(C57), (A2)+(B1)+(C58), (A2)+(B1)+(C59), (A2)+(B1)+(C60), (A2)+(B1)+(C61), (A2)+(B1)+(C62), (A2)+(B1)+(C63), (A2)+(B1)+(C64), (A2)+(B1)+(C65);

(A2)+(B2)+(C1), (A2)+(B2)+(C2), (A2)+(B2)+(C3), (A2)+(B2)+(C4), (A2)+(B2)+(C5), (A2)+(B2)+(C6), (A2)+(B2)+(C7), (A2)+(B2)+(C8), (A2)+(B2)+(C9), (A2)+(B2)+(C10), (A2)+(B2)+(C11), (A2)+(B2)+(C12), (A2)+(B2)+(C13), (A2)+(B2)+(C14), (A2)+(B2)+(C15), (A2)+(B2)+(C16), (A2)+(B2)+(C17), (A2)+(B2)+(C18), (A2)+(B2)+(C19), (A2)+(B2)+(C20), (A2)+(B2)+(C21), (A2)+(B2)+(C22), (A2)+(B2)+(C23), (A2)+(B2)+(C24), (A2)+(B2)+(C25), (A2)+(B2)+(C26), (A2)+(B2)+(C27), (A2)+(B2)+(C28), (A2)+(B2)+(C29), (A2)+(B2)+(C30), (A2)+(B2)+(C31), (A2)+(B2)+(C32), (A2)+(B2)+(C33), (A2)+(B2)+(C34), (A2)+(B2)+(C35), (A2)+(B2)+(C36), (A2)+(B2)+(C37), (A2)+(B2)+(C38), (A2)+(B2)+(C39), (A2)+(B2)+(C40), (A2)+(B2)+(C41), (A2)+(B2)+(C42), (A2)+(B2)+(C43), (A2)+(B2)+(C44), (A2)+(B2)+(C45), (A2)+(B2)+(C46), (A2)+(B2)+(C47), (A2)+(B2)+(C48), (A2)+(B2)+(C49), (A2)+(B2)+(C50), (A2)+(B2)+(C51), (A2)+(B2)+(C52), (A2)+(B2)+(C53), (A2)+(B2)+(C54), (A2)+(B2)+(C55), (A2)+(B2)+(C56), (A2)+(B2)+(C57), (A2)+(B2)+(C58), (A2)+(B2)+(C59), (A2)+(B2)+(C60), (A2)+(B2)+(C61), (A2)+(B2)+(C62), (A2)+(B2)+(C63), (A2)+(B2)+(C64), (A2)+(B2)+(C65);

(A1)+(A2)+(B1)+(B2)+(C1), (A1)+(A2)+(B1)+(B2)+(C2), (A1)+(A2)+(B1)+(B2)+(C3), (A1)+(A2)+(B1)+(B2)+(C4), (A1)+(A2)+(B1)+(B2)+(C5), (A1)+(A2)+(B1)+(B2)+(C6), (A1)+(A2)+(B1)+(B2)+(C7), (A1)+(A2)+(B1)+(B2)+(C8), (A1)+(A2)+(B1)+(B2)+(C9), (A1)+(A2)+(B1)+(B2)+(C10), (A1)+(A2)+(B1)+(B2)+(C11), (A1)+(A2)+(B1)+(B2)+(C12), (A1)+(A2)+(B1)+(B2)+(C13), (A1)+(A2)+(B1)+(B2)+(C14), (A1)+(A2)+(B1)+(B2)+(C15), (A1)+(A2)+(B1)+(B2)+(C16), (A1)+(A2)+(B1)+(B2)+(C17), (A1)+(A2)+(B1)+(B2)+(C18), (A1)+(A2)+(B1)+(B2)+(C19), (A1)+(A2)+(B1)+(B2)+(C20), (A1)+(A2)+(B1)+(B2)+(C21), (A1)+(A2)+(B1)+(B2)+(C22), (A1)+(A2)+(B1)+(B2)+(C23), (A1)+(A2)+(B1)+(B2)+(C24), (A1)+(A2)+(B1)+(B2)+(C25), (A1)+(A2)+(B1)+(B2)+(C26), (A1)+(A2)+(B1)+(B2)+(C27), (A1)+(A2)+(B1)+(B2)+(C28), (A1)+(A2)+(B1)+(B2)+(C29), (A1)+(A2)+(B1)+(B2)+(C30), (A1)+(A2)+(B1)+(B2)+(C31), (A1)+(A2)+(B1)+(B2)+(C32), (A1)+(A2)+(B1)+(B2)+(C33), (A1)+(A2)+(B1)+(B2)+(C34), (A1)+(A2)+(B1)+(B2)+(C35), (A1)+(A2)+(B1)+(B2)+(C36), (A1)+(A2)+(B1)+(B2)+(C37), (A1)+(A2)+(B1)+(B2)+(C38), (A1)+(A2)+(B1)+(B2)+(C39), (A1)+(A2)+(B1)+(B2)+(C40), (A1)+(A2)+(B1)+(B2)+(C41), (A1)+(A2)+(B1)+(B2)+(C42), (A1)+(A2)+(B1)+(B2)+(C43), (A1)+(A2)+(B1)+(B2)+(C44), (A1)+(A2)+(B1)+(B2)+(C45), (A1)+(A2)+(B1)+(B2)+(C46), (A1)+(A2)+(B1)+(B2)+(C47), (A1)+(A2)+(B1)+(B2)+(C48), (A1)+(A2)+(B1)+(B2)+(C49), (A1)+(A2)+(B1)+(B2)+(C50), (A1)+(A2)+(B1)+(B2)+(C51), (A1)+(A2)+(B1)+(B2)+(C52), (A1)+(A2)+(B1)+(B2)+(C53), (A1)+(A2)+(B1)+(B2)+(C54), (A1)+(A2)+(B1)+(B2)+(C55), (A1)+(A2)+(B1)+(B2)+(C56), (A1)+(A2)+(B1)+(B2)+(C57), (A1)+(A2)+(B1)+(B2)+(C58), (A1)+(A2)+(B1)+(B2)+(C59), (A1)+(A2)+(B1)+(B2)+(C60), (A1)+(A2)+(B1)+(B2)+(C61), (A1)+(A2)+(B1)+(B2)+(C62), (A1)+(A2)+(B1)+(B2)+(C63), (A1)+(A2)+(B1)+(B2)+(C64), (A1)+(A2)+(B1)+(B2)+(C65).

In addition, each of the herbicide combinations mentioned above may also comprise one or more safeners, in particular a safener such as mefenpyr-diethyl (S1-1), isoxadifen-ethyl (S1-9) and cloquintocet-mexyl (S2-1). In each case, the ranges of application rates and the ratios of application rates mentioned above are preferred. Examples are the herbicide combinations mentioned below.

(A1)+(B1)+(C1)+(S1-1), (A1)+(B1)+(C2)+(S1-1), (A1)+(B1)+(C3)+(S1-1), (A1)+(B1)+(C4)+(S1-1), (A1)+(B1)+(C5)+(S1-1), (A1)+(B1)+(C6)+(S1-1), (A1)+(B1)+(C7)+(S1-1), (A1)+(B1)+(C8)+(S1-1), (A1)+(B1)+(C9)+(S1-1), (A1)+(B1)+(C10)+(S1-1), (A1)+(B1)+(C11)+(S1-1), (A1)+(B1)+(C12)+(S1-1), (A1)+(B1)+(C13)+(S1-1), (A1)+(B1)+(C14)+(S1-1), (A1)+(B1)+(C15)+(S1-1), (A1)+(B1 )+(C16)+(S1-1), (A1)+(B1)+(C17)+(S1-1), (A1)+(B1)+(C18)+(S1-1), (A1)+(B1)+(C19)+(S1-1), (A1)+(B1)+(C20)+(S1-1), (A1)+(B1)+(C21)+(S1-1), (A1)+(B1)+(C22)+(S1-1), (A1)+(B1)+(C23)+(S1-1), (A1)+(B1)+(C24)+(S1-1), (A1)+(B1)+(C25)+(S1-1), (A1)+(B1)+(C26)+(S1-1), (A1)+(B1)+(C27)+(S1-1), (A1)+(B1)+(C28)+(S1-1), (A1)+(B1)+(C29)+(S1-1), (A1)+(B1)+(C30)+(S1-1), (A1)+(B1)+(C31)+(S1-1), (A1)+(B1)+(C32)+(S1-1), (A1)+(B1)+(C33)+(S1-1), (A1)+(B1)+(C34)+(S1-1), (A1)+(B1)+(C35)+(S1-1), (A1)+(B1)+(C36)+(S1-1), (A1)+(B1)+(C37)+(S1-1), (A1)+(B1)+(C38)+(S1-1), (A1)+(B1)+(C39)+(S1-1), (A1)+(B1)+(C40)+(S1-1), (A1)+(B1)+(C41)+(S1-1), (A1)+(B1)+(C42)+(S1-1), (A1)+(B1)+(C43)+(S1-1), (A1)+(B1)+(C44)+(S1-1), (A1)+(B1)+(C45)+(S1-1), (A1)+(B1)+(C46)+(S1-1), (A1)+(B1)+(C47)+(S1-1), (A1)+(B1)+(C48)+(S1-1), (A1)+(B1)+(C49)+(S1-1), (A1)+(B1)+(C50)+(S1-1), (A1)+(B1)+(C51)+(S1-1), (A1)+(B1)+(C52)+(S1-1), (A1)+(B1)+(C53)+(S1-1), (A1)+(B1)+(C54)+(S1-1), (A1)+(B1)+(C55)+(S1-1), (A1)+(B1)+(C56)+(S1-1), (A1)+(B1)+(C57)+(S1-1), (A1)+(B1)+(C58)+(S1-1), (A1)+(B1)+(C59)+(S1-1), (A1)+(B1)+(C60)+(S1-1), (A1)+(B1)+(C61)+(S1-1), (A1)+(B1)+(C62)+(S1-1), (A1)+(B1)+(C63)+(S1-1), (A1)+(B1)+(C64)+(S1-1), (A1)+(B1)+(C65)+(S1-1);

(A1)+(B2)+(C1)+(S1-1), (A1)+(B2)+(C2)+(S1-1), (A1)+(B2)+(C3)+(S1-1), (A1)+(B2)+(C4)+(S1-1), (A1)+(B2)+(C5)+(S1-1), (A1)+(B2)+(C6)+(S1-1), (A1)+(B2)+(C7)+(S1-1), (A1)+(B2)+(C8)+(S1-1), (A1)+(B2)+(C9)+(S1-1), (A1)+(B2)+(C10)+(S1-1), (A1)+(B2)+(C11)+(S1-1), (A1)+(B2)+(C12)+(S1-1), (A1)+(B2)+(C13)+(S1-1), (A1)+(B2)+(C14)+(S1-1), (A1)+(B2)+(C15)+(S1-1), (A1)+(B2)+(C16)+(S1-1), (A1)+(B2)+(C17)+(S1-1), (A1)+(B2)+(C18)+(S1-1), (A1)+(B2)+(C19)+(S1-1), (A1)+(B2)+(C20)+(S1-1), (A1)+(B2)+(C21)+(S1-1), (A1)+(B2)+(C22)+(S1-1), (A1)+(B2)+(C23)+(S1-1), (A1)+(B2)+(C24)+(S1-1), (A1)+(B2)+(C25)+(S1-1), (A1)+(B2)+(C26)+(S1-1), (A1)+(B2)+(C27)+(S1-1), (A1)+(B2)+(C28)+(S1-1), (A1)+(B2)+(C29)+(S1-1), (A1)+(B2)+(C30)+(S1-1), (A1)+(B2)+(C31)+(S1-1), (A1)+(B2)+(C32)+(S1-1), (A1)+(B2)+(C33)+(S1-1), (A1)+(B2)+(C34)+(S1-1), (A1)+(B2)+(C35)+(S1-1), (A1)+(B2)+(C36)+(S1-1), (A1)+(B2)+(C37)+(S1-1), (A1)+(B2)+(C38)+(S1-1), (A1)+(B2)+(C39)+(S1-1), (A1)+(B2)+(C40)+(S1-1), (A1)+(B2)+(C41)+(S1-1), (A1)+(B2)+(C42)+(S1-1), (A1)+(B2)+(C43)+(S1-1), (A1)+(B2)+(C44)+(S1-1), (A1)+(B2)+(C45)+(S1-1), (A1)+(B2)+(C46)+(S1-1), (A1)+(B2)+(C47)+(S1-1), (A1)+(B2)+(C48)+(S1-1), (A1)+(B2)+(C49)+(S1-1), (A1)+(B2)+(C50)+(S1-1), (A1)+(B2)+(C51)+(S1-1), (A1)+(B2)+(C52)+(S1-1), (A1)+(B2)+(C53)+(S1-1), (A1)+(B2)+(C54)+(S1-1), (A1)+(B2)+(C55)+(S1-1), (A1)+(B2)+(C56)+(S1-1), (A1)+(B2)+(C57)+(S1-1), (A1)+(B2)+(C58)+(S1-1), (A1)+(B2)+(C59)+(S1-1), (A1)+(B2)+(C60)+(S1-1), (A1)+(B2)+(C61)+(S1-1), (A1)+(B2)+(C62)+(S1-1), (A1)+(B2)+(C63)+(S1-1), (A1)+(B2)+(C64)+(S1-1), (A1)+(B2)+(C65)+(S1-1);

(A2)+(B1)+(C1)+(S1-1), (A2)+(B1)+(C2)+(S1-1), (A2)+(B1)+(C3)+(S1-1), (A2)+(B1)+(C4)+(S1-1), (A2)+(B1)+(C5)+(S1-1), (A2)+(B1)+(C6)+(S1-1), (A2)+(B1)+(C7)+(S1-1), (A2)+(B1)+(C8)+(S1-1), (A2)+(B1)+(C9)+(S1-1), (A2)+(B1)+(C10)+(S1-1), (A2)+(B1)+(C11)+(S1-1), (A2)+(B1)+(C12)+(S1-1), (A2)+(B1)+(C13)+(S1-1), (A2)+(B1)+(C14)+(S1-1), (A2)+(B1)+(C15)+(S1-1), (A2)+(B1)+(C16)+(S1-1), (A2)+(B1)+(C17)+(S1-1), (A2)+(B1)+(C18)+(S1-1), (A2)+(B1)+(C19)+(S1-1), (A2)+(B1)+(C20)+(S1-1), (A2)+(B1)+(C21)+(S1-1), (A2)+(B1)+(C22)+(S1-1), (A2)+(B1)+(C23)+(S1-1), (A2)+(B1)+(C24)+(S1-1), (A2)+(B1)+(C25)+(S1-1), (A2)+(B1)+(C26)+(S1-1), (A2)+(B1)+(C27)+(S1-1), (A2)+(B1)+(C28)+(S1-1), (A2)+(B1)+(C29)+(S1-1), (A2)+(B1)+(C30)+(S1-1), (A2)+(B1)+(C31)+(S1-1), (A2)+(B1)+(C32)+(S1-1), (A2)+(B1)+(C33)+(S1-1), (A2)+(B1)+(C34)+(S1-1), (A2)+(B1)+(C35)+(S1-1), (A2)+(B1)+(C36)+(S1-1), (A2)+(B1)+(C37)+(S1-1), (A2)+(B1)+(C38)+(S1-1), (A2)+(B1)+(C39)+(S1-1), (A2)+(B1)+(C40)+(S1-1), (A2)+(B1)+(C41)+(S1-1), (A2)+(B1)+(C42)+(S1-1), (A2)+(B1)+(C43)+(S1-1), (A2)+(B1)+(C44)+(S1-1), (A2)+(B1)+(C45)+(S1-1), (A2)+(B1)+(C46)+(S1-1), (A2)+(B1)+(C47)+(S1-1), (A2)+(B1)+(C48)+(S1-1), (A2)+(B1)+(C49)+(S1-1), (A2)+(B1)+(C50)+(S1-1), (A2)+(B1)+(C51)+(S1-1), (A2)+(B1)+(C52)+(S1-1), (A2)+(B1)+(C53)+(S1-1), (A2)+(B1)+(C54)+(S1-1), (A2)+(B1)+(C55)+(S1-1), (A2)+(B1)+(C56)+(S1-1), (A2)+(B1)+(C57)+(S1-1), (A2)+(B1)+(C58)+(S1-1), (A2)+(B1)+(C59)+(S1-1), (A2)+(B1)+(C60)+(S1-1), (A2)+(B1)+(C61)+(S1-1), (A2)+(B1)+(C62)+(S1-1), (A2)+(B1)+(C63)+(S1-1), (A2)+(B1)+(C64)+(S1-1), (A2)+(B1)+(C65)+(S1-1);

(A2)+(B2)+(C1)+(S1-1), (A2)+(B2)+(C2)+(S1-1), (A2)+(B2)+(C3)+(S1-1), (A2)+(B2)+(C4)+(S1-1), (A2)+(B2)+(C5)+(S1-1), (A2)+(B2)+(C6)+(S1-1), (A2)+(B2)+(C7)+(S1-1), (A2)+(B2)+(C8)+(S1-1), (A2)+(B2)+(C9)+(S1-1), (A2)+(B2)+(C10)+(S1-1), (A2)+(B2)+(C11)+(S1-1), (A2)+(B2)+(C12)+(S1-1), (A2)+(B2)+(C13)+(S1-1), (A2)+(B2)+(C14)+(S1-1), (A2)+(B2)+(C15)+(S1-1), (A2)+(B2)+(C16)+(S1-1), (A2)+(B2)+(C17)+(S1-1), (A2)+(B2)+(C18)+(S1-1), (A2)+(B2)+(C19)+(S1-1), (A2)+(B2)+(C20)+(S1-1), (A2)+(B2)+(C21)+(S1-1), (A2)+(B2)+(C22)+(S1-1), (A2)+(B2)+(C23)+(S1-1), (A2)+(B2)+(C24)+(S1-1), (A2)+(B2)+(C25)+(S1-1), (A2)+(B2)+(C26)+(S1-1), (A2)+(B2)+(C27)+(S1-1), (A2)+(B2)+(C28)+(S1-1), (A2)+(B2)+(C29)+(S1-1), (A2)+(B2)+(C30)+(S1-1), (A2)+(B2)+(C31)+(S1-1), (A2)+(B2)+(C32)+(S1-1), (A2)+(B2)+(C33)+(S1-1), (A2)+(B2)+(C34)+(S1-1), (A2)+(B2)+(C35)+(S1-1), (A2)+(B2)+(C36)+(S1-1), (A2)+(B2)+(C37)+(S1-1), (A2)+(B2)+(C38)+(S1-1), (A2)+(B2)+(C39)+(S1-1), (A2)+(B2)+(C40)+(S1-1), (A2)+(B2)+(C41)+(S1-1), (A2)+(B2)+(C42)+(S1-1), (A2)+(B2)+(C43)+(S1-1), (A2)+(B2)+(C44)+(S1-1), (A2)+(B2)+(C45)+(S1-1), (A2)+(B2)+(C46)+(S1-1), (A2)+(B2)+(C47)+(S1-1), (A2)+(B2)+(C48)+(S1-1), (A2)+(B2)+(C49)+(S1-1), (A2)+(B2)+(C50)+(S1-1), (A2)+(B2)+(C51)+(S1-1), (A2)+(B2)+(C52)+(S1-1), (A2)+(B2)+(C53)+(S1-1), (A2)+(B2)+(C54)+(S1-1), (A2)+(B2)+(C55)+(S1-1), (A2)+(B2)+(C56)+(S1-1), (A2)+(B2)+(C57)+(S1-1), (A2)+(B2)+(C58)+(S1-1), (A2)+(B2)+(C59)+(S1-1), (A2)+(B2)+(C60)+(S1-1), (A2)+(B2)+(C61)+(S1-1), (A2)+(B2)+(C62)+(S1-1), (A2)+(B2)+(C63)+(S1-1), (A2)+(B2)+(C64)+(S1-1), (A2)+(B2)+(C65)+(S1-1);

(A1)+(A2)+(B1)+(B2)+(C1)+(S1-1), (A1)+(A2)+(B1)+(B2)+(C2)+(S1-1), (A1)+(A2)+(B1)+(B2)+(C3)+(S1-1), (A1)+(A2)+(B1)+(B2)+(C4)+(S1-1), (A1)+(A2)+(B1)+(B2)+(C5)+(S1-1), (A1)+(A2)+(B1)+(B2)+(C6)+(S1-1), (A1)+(A2)+(B1)+(B2)+(C7)+(S1-1), (A1)+(A2)+(B1)+(B2)+(C8)+(S1-1), (A1)+(A2)+(B1)+(B2)+(C9)+(S1-1), (A1)+(A2)+(B1)+(B2)+(C10)+(S1-1), (A1)+(A2)+(B1)+(B2)+(C11)+(S1-1), (A1)+(A2)+(B1)+(B2)+(C12)+(S1-1), (A1)+(A2)+(B1)+(B2)+(C13)+(S1-1), (A1)+(A2)+(B1)+(B2)+(C14)+(S1-1), (A1)+(A2)+(B1)+(B2)+(C15)+(S1-1), (A1)+(A2)+(B1)+(B2)+(C16)+(S1-1), (A1)+(A2)+(B1)+(B2)+(C17)+(S1-1), (A1)+(A2)+(B1)+(B2)+(C18)+(S1-1), (A1)+(A2)+(B1)+(B2)+(C19)+(S1-1), (A1)+(A2)+(B1)+(B2)+(C20)+(S1-1), (A1)+(A2)+(B1)+(B2)+(C21)+(S1-1), (A1)+(A2)+(B1)+(B2)+(C22)+(S1-1), (A1)+(A2)+(B1)+(B2)+(C23)+(S1-1), (A1)+(A2)+(B1)+(B2)+(C24)+(S1-1), (A1)+(A2)+(B1)+(B2)+(C25)+(S1-1), (A1)+(A2)+(B1)+(B2)+(C26)+(S1-1), (A1)+(A2)+(B1)+(B2)+(C27)+(S1-1), (A1)+(A2)+(B1)+(B2)+(C28)+(S1-1), (A1)+(A2)+(B1)+(B2)+(C29)+(S1-1), (A1)+(A2)+(B1)+(B2)+(C30)+(S1-1), (A1)+(A2)+(B1)+(B2)+(C31)+(S1-1), (A1)+(A2)+(B1)+(B2)+(C32)+(S1-1), (A1)+(A2)+(B1)+(B2)+(C33)+(S1-1), (A1)+(A2)+(B1)+(B2)+(C34)+(S1-1), (A1)+(A2)+(B1)+(B2)+(C35)+(S1-1), (A1)+(A2)+(B1)+(B2)+(C36)+(S1-1), (A1)+(A2)+(B1)+(B2)+(C37)+(S1-1), (A1)+(A2)+(B1)+(B2)+(C38)+(S1-1), (A1)+(A2)+(B1)+(B2)+(C39)+(S1-1), (A1)+(A2)+(B1)+(B2)+(C40)+(S1-1), (A1)+(A2)+(B1)+(B2)+(C41)+(S1-1), (A1)+(A2)+(B1)+(B2)+(C42)+(S1-1), (A1)+(A2)+(B1)+(B2)+(C43)+(S1-1), (A1)+(A2)+(B1)+(B2)+(C44)+(S1-1), (A1)+(A2)+(B1)+(B2)+(C45)+(S1-1), (A1)+(A2)+(B1)+(B2)+(C46)+(S1-1), (A1)+(A2)+(B1)+(B2)+(C47)+(S1-1), (A1)+(A2)+(B1)+(B2)+(C48)+(S1-1), (A1)+(A2)+(B1)+(B2)+(C49)+(S1-1), (A1)+(A2)+(B1)+(B2)+(C50)+(S1-1), (A1)+(A2)+(B1)+(B2)+(C51)+(S1-1), (A1)+(A2)+(B1)+(B2)+(C52)+(S1-1), (A1)+(A2)+(B1)+(B2)+(C53)+(S1-1), (A1)+(A2)+(B1)+(B2)+(C54)+(S1-1), (A1)+(A2)+(B1)+(B2)+(C55)+(S1-1), (A1)+(A2)+(B1)+(B2)+(C56)+(S1-1), (A1)+(A2)+(B1)+(B2)+(C57)+(S1-1), (A1)+(A2)+(B1)+(B2)+(C58)+(S1-1), (A1)+(A2)+(B1)+(B2)+(C59)+(S1-1), (A1)+(A2)+(B1)+(B2)+(C60)+(S1-1), (A1)+(A2)+(B1)+(B2)+(C61)+(S1-1), (A1)+(A2)+(B1)+(B2)+(C62)+(S1-1), (A1)+(A2)+(B1)+(B2)+(C63)+(S1-1), (A1)+(A2)+(B1)+(B2)+(C64)+(S1-1), (A1)+(A2)+(B1)+(B2)+(C65)+(S1-1);

(A1)+(B1)+(C1)+(S1-9), (A1)+(B1)+(C2)+(S1-9), (A1)+(B1)+(C3)+(S1-9), (A1)+(B1)+(C4)+(S1-9), (A1)+(B1)+(C5)+(S1-9), (A1)+(B1)+(C6)+(S1-9), (A1)+(B1)+(C7)+(S1-9), (A1)+(B1)+(C8)+(S1-9), (A1)+(B1)+(C9)+(S1-9), (A1)+(B1)+(C10)+(S1-9), (A1)+(B1)+(C11)+(S1-9), (A1)+(B1)+(C12)+(S1-9), (A1)+(B1)+(C13)+(S1-9), (A1)+(B1)+(C14)+(S1-9), (A1)+(B1)+(C15)+(S1-9), (A1)+(B1)+(C16)+(S1-9), (A1)+(B1)+(C17)+(S1-9), (A1)+(B1)+(C18)+(S1-9), (A1)+(B1)+(C19)+(S1-9), (A1)+(B1)+(C20)+(S1-9), (A1)+(B1)+(C21)+(S1-9), (A1)+(B1)+(C22)+(S1-9), (A1)+(B1)+(C23)+(S1-9), (A1)+(B1)+(C24)+(S1-9), (A1)+(B1)+(C25)+(S1-9), (A1)+(B1)+(C26)+(S1-9), (A1)+(B1)+(C27)+(S1-9), (A1)+(B1)+(C28)+(S1-9), (A1)+(B1)+(C29)+(S1-9), (A1)+(B1)+(C30)+(S1-9), (A1)+(B1)+(C31)+(S1-9), (A1)+(B1)+(C32)+(S1-9), (A1)+(B1)+(C33)+(S1-9), (A1)+(B1)+(C34)+(S1-9), (A1)+(B1)+(C35)+(S1-9), (A1)+(B1)+(C36)+(S1-9), (A1)+(B1)+(C37)+(S1-9), (A1)+(B1)+(C38)+(S1-9), (A1)+(B1)+(C39)+(S1-9), (A1)+(B1)+(C40)+(S1-9), (A1)+(B1)+(C41)+(S1-9), (A1)+(B1)+(C42)+(S1-9), (A1)+(B1)+(C43)+(S1-9), (A1)+(B1)+(C44)+(S1-9), (A1)+(B1)+(C45)+(S1-9), (A1)+(B1)+(C46)+(S1-9), (A1)+(B1)+(C47)+(S1-9), (A1)+(B1)+(C48)+(S1-9), (A1)+(B1)+(C49)+(S1-9), (A1)+(B1)+(C50)+(S1-9), (A1)+(B1)+(C51)+(S1-9), (A1)+(B1)+(C52)+(S1-9), (A1)+(B1)+(C53)+(S1-9), (A1)+(B1)+(C54)+(S1-9), (A1)+(B1)+(C55)+(S1-9), (A1)+(B1)+(C56)+(S1-9), (A1)+(B1)+(C57)+(S1-9), (A1)+(B1)+(C58)+(S1-9), (A1)+(B1)+(C59)+(S1-9), (A1)+(B1)+(C60)+(S1-9), (A1)+(B1)+(C61)+(S1-9), (A1)+(B1)+(C62)+(S1-9), (A1)+(B1)+(C63)+(S1-9), (A1)+(B1)+(C64)+(S1-9), (A1)+(B1)+(C65)+(S1-9);

(A1)+(B2)+(C1)+(S1-9), (A1)+(B2)+(C2)+(S1-9), (A1)+(B2)+(C3)+(S1-9), (A1)+(B2)+(C4)+(S1-9), (A1)+(B2)+(C5)+(S1-9), (A1)+(B2)+(C6)+(S1-9), (A1)+(B2)+(C7)+(S1-9), (A1)+(B2)+(C8)+(S1-9), (A1)+(B2)+(C9)+(S1-9), (A1)+(B2)+(C10)+(S1-9), (A1)+(B2)+(C11)+(S1-9), (A1)+(B2)+(C12)+(S1-9), (A1)+(B2)+(C13)+(S1-9), (A1)+(B2)+(C14)+(S1-9), (A1)+(B2)+(C15)+(S1-9), (A1)+(B2)+(C16)+(S1-9), (A1)+(B2)+(C17)+(S1-9), (A1)+(B2)+(C18)+(S1-9), (A1)+(B2)+(C19)+(S1-9), (A1)+(B2)+(C20)+(S1-9), (A1)+(B2)+(C21)+(S1-9), (A1)+(B2)+(C22)+(S1-9), (A1)+(B2)+(C23)+(S1-9), (A1)+(B2)+(C24)+(S1-9), (A1)+(B2)+(C25)+(S1-9), (A1)+(B2)+(C26)+(S1-9), (A1)+(B2)+(C27)+(S1-9), (A1)+(B2)+(C28)+(S1-9), (A1)+(B2)+(C29)+(S1-9), (A1)+(B2)+(C30)+(S1-9), (A1)+(B2)+(C31)+(S1-9), (A1)+(B2)+(C32)+(S1-9), (A1)+(B2)+(C33)+(S1-9), (A1)+(B2)+(C34)+(S1-9), (A1)+(B2)+(C35)+(S1-9), (A1)+(B2)+(C36)+(S1-9), (A1)+(B2)+(C37)+(S1-9), (A1)+(B2)+(C38)+(S1-9), (A1)+(B2)+(C39)+(S1-9), (A1)+(B2)+(C40)+(S1-9), (A1)+(B2)+(C41)+(S1-9), (A1)+(B2)+(C42)+(S1-9), (A1)+(B2)+(C43)+(S1-9), (A1)+(B2)+(C44)+(S1-9), (A1)+(B2)+(C45)+(S1-9), (A1)+(B2)+(C46)+(S1-9), (A1)+(B2)+(C47)+(S1-9), (A1)+(B2)+(C48)+(S1-9), (A1)+(B2)+(C49)+(S1-9), (A1)+(B2)+(C50)+(S1-9), (A1)+(B2)+(C51)+(S1-9), (A1)+(B2)+(C52)+(S1-9), (A1)+(B2)+(C53)+(S1-9), (A1)+(B2)+(C54)+(S1-9), (A1)+(B2)+(C55)+(S1-9), (A1)+(B2)+(C56)+(S1-9), (A1)+(B2)+(C57)+(S1-9), (A1)+(B2)+(C58)+(S1-9), (A1)+(B2)+(C59)+(S1-9), (A1)+(B2)+(C60)+(S1-9), (A1)+(B2)+(C61)+(S1-9), (A1)+(B2)+(C62)+(S1-9), (A1)+(B2)+(C63)+(S1-9), (A1)+(B2)+(C64)+(S1-9), (A1)+(B2)+(C65)+(S1-9);

(A2)+(B1)+(C1)+(S1-9), (A2)+(B1)+(C2)+(S1-9), (A2)+(B1)+(C3)+(S1-9), (A2)+(B1)+(C4)+(S1-1), (A2)+(B1)+(C5)+(S1-9), (A2)+(B1)+(C6)+(S1-9), (A2)+(B1)+(C7)+(S1-9), (A2)+(B1)+(C8)+(S1-9), (A2)+(B1)+(C9)+(S1-9), (A2)+(B1)+(C10)+(S1-9), (A2)+(B1)+(C11)+(S1-9), (A2)+(B1)+(C12)+(S1-9), (A2)+(B1)+(C13)+(S1-9), (A2)+(B1)+(C14)+(S1-9), (A2)+(B1)+(C15)+(S1-9), (A2)+(B1)+(C16)+(S1-9), (A2)+(B1)+(C17)+(S1-9), (A2)+(B1)+(C18)+(S1-9), (A2)+(B1)+(C19)+(S1-9), (A2)+(B1)+(C20)+(S1-9), (A2)+(B1)+(C21)+(S1-9), (A2)+(B1)+(C22)+(S1-9), (A2)+(B1)+(C23)+(S1-9), (A2)+(B1)+(C24)+(S1-9), (A2)+(B1)+(C25)+(S1-9), (A2)+(B1)+(C26)+(S1-9), (A2)+(B1)+(C27)+(S1-9), (A2)+(B1)+(C28)+(S1-9), (A2)+(B1)+(C29)+(S1-9), (A2)+(B1)+(C30)+(S1-9), (A2)+(B1)+(C31)+(S1-9), (A2)+(B1)+(C32)+(S1-9), (A2)+(B1)+(C33)+(S1-9), (A2)+(B1)+(C34)+(S1-9), (A2)+(B1)+(C35)+(S1-9), (A2)+(B1)+(C36)+(S1-9), (A2)+(B1)+(C37)+(S1-9), (A2)+(B1)+(C38)+(S1-9), (A2)+(B1)+(C39)+(S1-9), (A2)+(B1)+(C40)+(S1-9), (A2)+(B1)+(C41)+(S1-9), (A2)+(B1)+(C42)+(S1-9), (A2)+(B1)+(C43)+(S1-9), (A2)+(B1)+(C44)+(S1-9), (A2)+(B1)+(C45)+(S1-9), (A2)+(B1)+(C46)+(S1-9), (A2)+(B1)+(C47)+(S1-9), (A2)+(B1)+(C48)+(S1-9), (A2)+(B1)+(C49)+(S1-9), (A2)+(B1)+(C50)+(S1-9), (A2)+(B1)+(C51)+(S1-9), (A2)+(B1)+(C52)+(S1-9), (A2)+(B1)+(C53)+(S1-9), (A2)+(B1)+(C54)+(S1-9), (A2)+(B1)+(C55)+(S1-9), (A2)+(B1)+(C56)+(S1-9), (A2)+(B1)+(C57)+(S1-9), (A2)+(B1)+(C58)+(S1-9), (A2)+(B1)+(C59)+(S1-9), (A2)+(B1)+(C60)+(S1-9), (A2)+(B1)+(C61)+(S1-9), (A2)+(B1)+(C62)+(S1-9), (A2)+(B1)+(C63)+(S1-9), (A2)+(B1)+(C64)+(S1-9), (A2)+(B1)+(C65)+(S1-9);

(A2)+(B2)+(C1)+(S1-9), (A2)+(B2)+(C2)+(S1-9), (A2)+(B2)+(C3)+(S1-9), (A2)+(B2)+(C4)+(S1-9), (A2)+(B2)+(C5)+(S1-9), (A2)+(B2)+(C6)+(S1-9), (A2)+(B2)+(C7)+(S1-9), (A2)+(B2)+(C8)+(S1-9), (A2)+(B2)+(C9)+(S1-9), (A2)+(B2)+(C10)+(S1-9), (A2)+(B2)+(C11)+(S1-9), (A2)+(B2)+(C12)+(S1-9), (A2)+(B2)+(C13)+(S1-9), (A2)+(B2)+(C14)+(S1-9), (A2)+(B2)+(C15)+(S31-9), (A2)+(B2)+(C16)+(S1-9), (A2)+(B2)+(C17)+(S1-9), (A2)+(B2)+(C18)+(S1-9), (A2)+(B2)+(C19)+(S1-9), (A2)+(B2)+(C20)+(S1-9), (A2)+(B2)+(C21)+(s1-9), (A2)+(B2)+(C22)+(S1-9), (A2)+(B2)+(C23)+(S1-9), (A2)+(B2)+(C24)+(S1-9), (A2)+(B2)+(C25)+(S1-9), (A2)+(B2)+(C26)+(S1-9), (A2)+(B2)+(C27)+(S1-9), (A2)+(B2)+(C28)+(S 1-9), (A2)+(B2)+(C29)+(S1-9), (A2)+(B2)+(C30)+(S1-9), (A2)+(B2)+(C31)+(S1-9), (A2)+(B2)+(C32)+(S1-9), (A2)+(B2)+(C33)+(S1-9), (A2)+(B2)+(C34)+(S1-9), (A2)+(B2)+(C35)+(S1-9), (A2)+(B2)+(C36)+(S1-9), (A2)+(B2)+(C37)+(S1-9), (A2)+(B2)+(C38)+(S1-9), (A2)+(B2)+(C39)+(S1-9), (A2)+(B2)+(C40)+(S1-9), (A2)+(B2)+(C41)+(S1-9), (A2)+(B2)+(C42)+(S1-9), (A2)+(B2)+(C43)+(S1-9), (A2)+(B2)+(C44)+(S1-9), (A2)+(B2)+(C45)+(S1-9), (A2)+(B2)+(C46)+(S1-9), (A2)+(B2)+(C47)+(S1-9), (A2)+(B2)+(C48)+(S1-9), (A2)+(B2)+(C49)+(S1-9), (A2)+(B2)+(C50)+(S1-9), (A2)+(B2)+(C51)+(S1-9), (A2)+(B2)+(C52)+(S1-9), (A2)+(B2)+(C53)+(S1-9), (A2)+(B2)+(C54)+(S1-9), (A2)+(B2)+(C55)+(S1-9), (A2)+(B2)+(C56)+(S1-9), (A2)+(B2)+(C57)+(S1-9), (A2)+(B2)+(C58)+(S1-9), (A2)+(B2)+(C59)+(S1-9), (A2)+(B2)+(C60)+(S1-9), (A2)+(B2)+(C61)+(S1-9), (A2)+(B2)+(C62)+(S1-9), (A2)+(B2)+(C63)+(S1-9), (A2)+(B2)+(C64)+(S1-9), (A2)+(B2)+(C65)+(S1-9);

(A1)+(A2)+(B1)+(B2)+(C1)+(S1-9), (A1)+(A2)+(B1)+(B2)+(C2)+(S1-9), (A1)+(A2)+(B1)+(B2)+(C3)+(S1-9), (A1)+(A2)+(B1)+(B2)+(C4)+(S1-9), (A1)+(A2)+(B1)+(B2)+(C5)+(S1-9), (A1)+(A2)+(B1)+(B2)+(C6)+(S1-9), (A1)+(A2)+(B1)+(B2)+(C7)+(S1-9), (A1)+(A2)+(B1)+(B2)+(C8)+(S1-9), (A1)+(A2)+(B1)+(B2)+(C9)+(S1-9), (A1)+(A2)+(B1)+(B2)+(C10)+(S1-9), (A1))+(A2)+(B1)+(B2)+(C11)+(S1-9), (A1)+(A2)+(B1)+(B2)+(C12)+(S1-9), (A1)+(A2)+(B1)+(B2)+(C13)+(S1-9), (A1)+(A2)+(B1)+(B2)+(C14)+(S1-9), (A1)+(A2)+(B1)+(B2)+(C15)+(S1-9), (A1)+(A2)+(B1)+(B2)+(C16)+(S1-9), (A1)+(A2)+(B1)+(B2)+(C17)+(S1-9), (A1)+(A2)+(B1)+(B2)+(C18)+(S1-9), (A1)+(A2)+(B1)+(B2)+(C19)+(S1-9), (A1)+(A2)+(B1)+(B2)+(C20)+(S1-9), (A1)+(A2)+(B1)+(B2)+(C21)+(S1-9), (A1)+(A2)+(B1)+(B2)+(C22)+(S1-9), (A1)+(A2)+(B1)+(B2)+(C23)+(S1-9), (A1)+(A2)+(B1)+(B2)+(C24)+(S1-9), (A1)+(A2)+(B1)+(B2)+(C25)+(S1-9), (A1)+(A2)+(B1)+(B2)+(C26)+(S1-9), (A1)+(A2)+(B1)+(B2)+(C27)+(S1-9), (A1)+(A2)+(B1)+(B2)+(C28)+(S1-9), (A1)+(A2)+(B1)+(B2)+(C29)+(S1-9), (A1)+(A2)+(B1)+(B2)+(C30)+(S1-9), (A1)+(A2)+(B1)+(B2)+(C31)+(S1-9), (A1)+(A2)+(B1)+(B2)+(C32)+(S1-9), (A1)+(A2)+(B1)+(B2)+(C33)+(S1-9), (A1)+(A2)+(B1)+(B2)+(C34)+(S1-9), (A1)+(A2)+(B1)+(B2)+(C35)+(S1-9), (A1)+(A2)+(B1)+(B2)+(C36)+(S1-9), (A1)+(A2)+(B1)+(B2)+(C37)+(S1-9), (A1)+(A2)+(B1)+(B2)+(C38)+(S1-9), (A1)+(A2)+(B1)+(B2)+(C39)+(S1-9), (A1)+(A2)+(B1)+(B2)+(C40)+(S1-9), (A1)+(A2)+(B1)+(B2)+(C41)+(S1-9), (A1)+(A2)+(B1)+(B2)+(C42)+(S1-9), (A1)+(A2)+(B1)+(B2)+(C43)+(S1-9), (A1)+(A2)+(B1)+(B2)+(C44)+(S1-9), (A1)+(A2)+(B1)+(B2)+(C45)+(S1-9), (A1)+(A2)+(B1)+(B2)+(C46)+(S1-9), (A1)+(A2)+(B1)+(B2)+(C47)+(S1-9), (A1)+(A2)+(B1)+(B2)+(C48)+(S1-9), (A1)+(A2)+(B1)+(B2)+(C49)+(S1-9), (A1)+(A2)+(B1)+(B2)+(C50)+(S1-9), (A1)+(A2)+(B1)+(B2)+(C51)+(S1-9), (A1)+(A2)+(B1)+(B2)+(C52)+(S1-9), (A1)+(A2)+(B1)+(B2)+(C53)+(S1-9), (A1)+(A2)+(B1)+(B2)+(C54)+(S1-9), (A1)+(A2)+(B1)+(B2)+(C55)+(S1-9), (A1)+(A2)+(B1)+(B2)+(C56)+(S1-9), (A1)+(A2)+(B1)+(B2)+(C57)+(S1-9), (A1)+(A2)+(B1)+(B2)+(C58)+(S1-9), (A1)+(A2)+(B1)+(B2)+(C59)+(S1-9), (A1)+(A2)+(B1)+(B2)+(C60)+(S1-9), (A1)+(A2)+(B1)+(B2)+(C61)+(S1-9), (A1)+(A2)+(B1)+(B2)+(C62)+(S1-9), (A1)+(A2)+(B1)+(B2)+(C63)+(S1-9), (A1)+(A2)+(B1)+(B2)+(C64)+(S1-9), (A1)+(A2)+(B1)+(B2)+(C65)+(S1-9);

(A1)+(B1)+(C1)+(S2-1), (A1)+(B1)+(C2)+(S2-1), (A1)+(B1)+(C3)+(S2-1), (A1)+(B1)+(C4)+(S2-1), (A1)+(B1)+(C5)+(S2-1), (A1)+(B1)+(C6)+(S2-1), (A1)+(B1)+(C7)+(S2-1), (A1)+(B1)+(C8)+(S2-1), (A1)+(B1)+(C9)+(S2-1), (A1)+(B1)+(C10)+(S2-1), (A1)+(B1)+(C11)+(S2-1), (A1)+(B1)+(C12)+(S2-1), (A1)+(B1)+(C13)+(S2-1), (A1)+(B1)+(C14)+(S2-1), (A1)+(B1)+(C15)+(S2-1), (A1)+(B1)+(C16)+(S2-1), (A1)+(B1)+(C17)+(S2-1), (A1)+(B1)+(C18)+(S2-1), (A1)+(B1)+(C19)+(S2-1), (A1)+(B1)+(C20)+(S2-1), (A1)+(B1)+(C21)+(S2-1), (A1)+(B1)+(C22)+(S2-1), (A1)+(B1)+(C23)+(S2-1), (A1)+(B1)+(C24)+(S2-1), (A1)+(B1)+(C25)+(S2-1), (A1)+(B1)+(C26)+(S2-1), (A1)+(B1)+(C27)+(S2-1), (A1)+(B1)+(C28)+(52-1), (A1)+(B1)+(C29)+(S2-1), (A1)+(B1)+(C30)+(S2-1), (A1)+(B1)+(C31)+(S2-1), (A1)+(B1)+(C32)+(S2-1), (A1)+(B1)+(C33)+(S2-1), (A1)+(B1)+(C34)+(S2-1), (A1)+(B1)+(C35)+(S2-1), (A1)+(B1)+(C36)+(S2-1), (A1)+(B1)+(C37)+(S2-1), (A1)+(B1)+(C38)+(S2-1), (A1)+(B1)+(C39)+(S2-1), (A1)+(B1)+(C40)+(S2-1), (A1)+(B1)+(C41)+(S2-1), (A1)+(B1)+(C42)+(S2-1), (A1)+(B1)+(C43)+(S2-1), (A1)+(B1)+(C44)+(S2-1), (A1)+(B1)+(C45)+(S2-1), (A1)+(B1)+(C46)+(S2-1), (A1)+(B1)+(C47)+(S2-1), (A1)+(B1)+(C48)+(S2-1), (A1)+(B1)+(C49)+(S2-1), (A1)+(B1)+(C50)+(S2-1), (A1)+(B1)+(C51)+(S2-1), (A1)+(B1)+(C52)+(S2-1), (A1)+(B1)+(C53)+(S2-1), (A1)+(B1)+(C54)+(S2-1), (A1)+(B1)+(C55)+(S2-1), (A1)+(B1)+(C56)+(S2-1), (A1)+(B1)+(C57)+(S2-1), (A1)+(B1)+(C58)+(S2-1), (A1)+(B1)+(C59)+(S2-1), (A1)+(B1)+(C60)+(S2-1), (A1)+(B1)+(C61)+(S2-1), (A1)+(B1)+(C62)+(S2-1), (A1)+(B1)+(C63)+(S2-1), (A1)+(B1)+(C64)+(S2-1), (A1)+(B1)+(C65)+(S2-1);

(A1)+(B2)+(C1)+(S2-1), (A1)+(B2)+(C2)+(S2-1), (A1)+(B2)+(C3)+(S2-1), (A1)+(B2)+(C4)+(S2-1), (A1)+(B2)+(C5)+(S2-1), (A1)+(B2)+(C6)+(S2-1), (A1)+(B2)+(C7)+(S2-1), (A1)+(B2)+(C8)+(S2-1), (A1)+(B2)+(C9)+(S2-1), (A1)+(B2)+(C10)+(S2-1), (A1)+(B2)+(C1)+(S2-1), (A1)+(B2)+(C12)+(S2-1), (A1)+(B2)+(C13)+(S2-1), (A1)+(B2)+(C14)+(S2-1), (A1)+(B2)+(C15)+(S2-1), (A1)+(B2)+(C16)+(S2-1), (A1)+(B2)+(C17)+(S2-1), (A1)+(B2)+(C8)+(S2-1), (A1)+(B2)+(C19)+(S2-1), (A1)+(B2)+(C20)+(S2-1), (A1)+(B2)+(C21)+(S2-1), (A1)+(B2)+(C22)+(S2-1), (A1)+(B2)+(C23)+(S2-1), (A1)+(B2)+(C24)+(S2-1), (A1)+(B2)+(C25)+(S2-1), (A1)+(B2)+(C26)+(S2-1), (A1)+(B2)+(C27)+(S2-1), (A1)+(B2)+(C28)+(S2-1), (A1)+(B2)+(C29)+(S2-1), (A1)+(B2)+(C30)+(S2-1), (A1)+(B2)+(C31)+(S2-1), (A1)+(B2)+(C32)+(S2-1), (A1)+(B2)+(C33)+(S2-1), (A1)+(B2)+(C34)+(S2-1), (A1)+(B2)+(C35)+(S2-1), (A1)+(B2)+(C36)+(S2-1), (A1)+(B2)+(C37)+(S2-1), (A1)+(B2)+(C38)+(S2-1), (A1)+(B2)+(C39)+(S2-1), (A1)+(B2)+(C40)+(S2-1), (A1)+(B2)+(C41)+(S2-1), (A1)+(B2)+(C42)+(S2-1), (A1)+(B2)+(C43)+(S2-1), (A1)+(B2)+(C44)+(S2-1), (A1)+(B2)+(C45)+(S2-1), (A1l)+(B2)+(C46)+(S2-1), (A1)+(B2)+(C47)+(S2-1), (A1)+(B2)+(C48)+(S2-1), (A1)+(B2)+(C49)+(S2-1), (A1)+(B2)+(C50)+(S2-1), (A1)+(B2)+(C51)+(S2-1), (A1)+(B2)+(C52)+(S2-1), (A1)+(B2)+(C53)+(S2-1), (A1)+(B2)+(C54)+(S2-1), (A1)+(B2)+(C55)+(S2-1), (A1)+(B2)+(C56)+(S2-1), (A1)+(B2)+(C57)+(S2-1), (A1)+(B2)+(C58)+(S2-1), (A1)+(B2)+(C59)+(S2-1), (A1)+(B2)+(C60)+(S2-1), (A1)+(B2)+(C61)+(S2-1), (A1)+(B2)+(C62)+(S2-1), (A1)+(B2)+(C63)+(S2-1), (A1)+(B2)+(C64)+(S2-1), (A1)+(B2)+(C65)+(S2-1);

(A2)+(B1)+(C1)+(S2-1), (A2)+(B1)+(C2)+(S2-1), (A2)+(B1)+(C3)+(S2-1), (A2)+(B1)+(C4)+(S2-1), (A2)+(B1)+(C5)+(S2-1), (A2)+(B1)+(C6)+(S2-1), (A2)+(B1)+(C7)+(S2-1), (A2)+(B1)+(C8)+(S2-1), (A2)+(B1)+(C9)+(S2-1), (A2)+(B1)+(C10)+(S2-1), (A2)+(B1)+(C11)+(S2-1), (A2)+(B1)+(C12)+(S2-1), (A2)+(B1)+(C23)+(S2-1), (A2)+(B1)+(C14)+(S2-1), (A2)+(B1)+(C15)+(S2-1), (A2)+(B1)+(C16)+(S2-1), (A2)+(B1)+(C17)+(S2-1), (A2)+(B1)+(C18)+(S2-1), (A2)+(B1)+(C19)+(S2-1), (A2)+(B1)+(C20)+(S2-1), (A2)+(B1)+(C21)+(S2-1), (A2)+(B1)+(C22)+(S2-1), (A2)+(B1)+(C23)+(S2-1), (A2)+(B1)+(C24)+(S2-1), (A2)+(B1)+(C25)+(S2-1), (A2)+(B1)+(C26)+(S2-1), (A2)+(B1)+(C27)+(S2-1), (A2)+(B1)+(C28)+(S2-1), (A2)+(B1)+(C29)+(S2-1), (A2)+(B1)+(C30)+(S2-1), (A2)+(B1)+(C31)+(S2-1), (A2)+(B1)+(C32)+(S2-1), (A2)+(B1)+(C33)+(S2-1), (A2)+(B1)+(C34)+(S2-1), (A2)+(B1)+(C35)+(S2-1), (A2)+(B1)+(C36)+(S2-1), (A2)+(B1)+(C37)+(S2-1), (A2)+(B1)+(C38)+(S2-1), (A2)+(B1)+(C39)+(S2-1), (A2)+(B1)+(C40)+(S2-1), (A2)+(B1)+(C41)+(S2-1), (A2)+(B1)+(C42)+(S2-1), (A2)+(B1)+(C43)+(S2-1), (A2)+(B1)+(C44)+(S2-1), (A2)+(B1)+(C45)+(S2-1), (A2)+(B1)+(C46)+(S2-1), (A2)+(B1)+(C47)+(S2-1), (A2)+(B1)+(C48)+(S2-1), (A2)+(B1)+(C49)+(S2-1), (A2)+(B1)+(C50)+(S2-1), (A2)+(B1)+(C51)+(S2-1), (A2)+(B1)+(C52)+(S2-1), (A2)+(B1)+(C53)+(S2-1), (A2)+(B1)+(C54)+(S2-1), (A2)+(B1)+(C55)+(S2-1), (A2)+(B1)+(C56)+(S2-1), (A2)+(B1)+(C57)+(S2-1), (A2)+(B1)+(C58)+(S2-1), (A2)+(B1)+(C59)+(S2-1), (A2)+(B1)+(C60)+(S2-1), (A2)+(B1)+(C61)+(S2-1), (A2)+(B1)+(C62)+(S2-1), (A2)+(B1)+(C63)+(S2-1), (A2)+(B1)+(C64)+(S2-1), (A2)+(B1)+(C65)+(S2-1);

(A2)+(B2)+(C1)+(S2-1), (A2)+(B2)+(C2)+(S2-1), (A2)+(B2)+(C3)+(S2-1), (A2)+(B2)+(C4)+(S2-1), (A2)+(B2)+(C5)+(S2-1), (A2)+(B2)+(C6)+(S2-1), (A2)+(B2)+(C7)+(S2-1), (A2)+(B2)+(C8)+(S2-1), (A2)+(B2)+(C9)+(S2-1), (A2)+(B2)+(C10)+(S2-1), (A2)+(B2)+(C11)+(S2-1), (A2)+(B2)+(C12)+(S2-1), (A2)+(B2)+(C13)+(S2-1), (A2)+(B2)+(C14)+(S2-1), (A2)+(B2)+(C15)+(S2-1), (A2)+(B2)+(C16)+(S2-1), (A2)+(B2)+(C17)+(S2-1), (A2)+(B2)+(C18)+(S2-1), (A2)+(B2)+(C19)+(S2-1), (A2)+(B2)+(C20)+(S2-1), (A2)+(B2)+(C21)+(S2-1), (A2)+(B2)+(C22)+(S2-1), (A2)+(B2)+(C23)+(S2-1), (A2)+(B2)+(C24)+(S2-1), (A2)+(B2)+(C25)+(S2-1), (A2)+(B2)+(C26)+(S2-1), (A2)+(B2)+(C27)+(S2-1), (A2)+(B2)+(C28)+(S2-1), (A2)+(B2)+(C29)+(S2-1), (A2)+(B2)+(C30)+(S2-1), (A2)+(B2)+(C31)+(S2-1), (A2)+(B2)+(C32)+(S2-1), (A2)+(B2)+(C33)+(S2-1), (A2)+(B2)+(C34)+(S2-1), (A2)+(B2)+(C35)+(S2-1), (A2)+(B2)+(C36)+(S2-1), (A2)+(B2)+(C37)+(S2-1), (A2)+(B2)+(C38)+(S2-1), (A2)+(B2)+(C39)+(S2-1), (A2)+(B2)+(C40)+(S2-1), (A2)+(B2)+(C41)+(S2-1), (A2)+(B2)+(C42)+(S2-1), (A2)+(B2)+(C43)+(S2-1), (A2)+(B2)+(C44)+(S2-1), (A2)+(B2)+(C45)+(S2-1), (A2)+(B2)+(C46)+(S2-1), (A2)+(B2)+(C47)+(S2-1), (A2)+(B2)+(C48)+(S2-1), (A2)+(B2)+(C49)+(S2-1), (A2)+(B2)+(C50)+(S2-1), (A2)+(B2)+(C51)+(S2-1), (A2)+(B2)+(C52)+(S2-1), (A2)+(B2)+(C53)+(S2-1), (A2)+(B2)+(C54)+(S2-1), (A2)+(B2)+(C55)+(S2-1), (A2)+(B2)+(C56)+(S2-1), (A2)+(B2)+(C57)+(S2-1), (A2)+(B2)+(C58)+(S2-1), (A2)+(B2)+(C59)+(S2-1), (A2)+(B2)+(C60)+(S2-1), (A2)+(B2)+(C61)+(S2-1), (A2)+(B2)+(C62)+(S2-1), (A2)+(B2)+(C63)+(S2-1), (A2)+(B2)+(C64)+(S2-1), (A2)+(B2)+(C65)+(S2-1);

(A1)+(A2)+(B1)+(B2)+(C1)+(S2-1), (A1)+(A2)+(B1)+(B2)+(C2)+(S2-1), (A1)+(A2)+(B1)+(B2)+(C3)+(S2-1), (A1)+(A2)+(B1)+(B2)+(C4)+(S2-1), (A1)+(A2)+(B1)+(B2)+(C5)+(S2-1), (A1)+(A2)+(B1)+(B2)+(C6)+(S2-1), (A1)+(A2)+(B1)+(B2)+(C7)+(S2-1), (A1)+(A2)+(B1)+(B2)+(C8)+(S2-1), (A1)+(A2)+(B1)+(B2)+(C9)+(S2-1), (A1)+(A2)+(B1)+(B2)+(C10)+(S2-1), (A1)+(A2)+(B1)+(B2)+(C11)+(S2-1), (A1)+(A2)+(B1)+(B2)+(C12)+(S2-1), (A1)+(A2)+(B1)+(B2)+(C13)+(S2-1), (A1)+(A2)+(B1)+(B2)+(C14)+(S2-1), (A1)+(A2)+(B1)+(B2)+(C15)+(S2-1), (A1)+(A2)+(B1)+(B2)+(C16)+(S2-1), (A1)+(A2)+(B1)+(B2)+(C17)+(S2-1), (A1)+(A2)+(B1)+(B2)+(C18)+(S2-1), (A1)+(A2)+(B1)+(B2)+(C19)+(S2-1), (A1)+(A2)+(B1)+(B2)+(C20)+(S2-1), (A1)+(A2)+(B1)+(B2)+(C21)+(S2-1), (A1)+(A2)+(B1)+(B2)+(C22)+(S2-1), (A1)+(A2)+(B1)+(B2)+(C23)+(S2-1), (A1)+(A2)+(B1)+(B2)+(C24)+(S2-1), (A1)+(A2)+(B1)+(B2)+(C25)+(S2-1), (A1)+(A2)+(B1)+(B2)+(C26)+(S2-1), (A1)+(A2)+(B1)+(B2)+(C27)+(S2-1), (A1)+(A2)+(B1)+(B2)+(C28)+(S2-1), (A1)+(A2)+(B1)+(B2)+(C29)+(S2-1), (A1)+(A2)+(B1)+(B2)+(C30)+(S2-1), (A1)+(A2)+(B1)+(B2)+(C31)+(S2-1), (A1)+(A2)+(B1)+(B2)+(C32)+(S2-1), (A1)+(A2)+(B1)+(B2)+(C33)+(S2-1), (A1)+(A2)+(B1)+(B2)+(C34)+(S2-1), (A1)+(A2)+(B1)+(B2)+(C35)+(S2-1), (A1)+(A2)+(B1)+(B2)+(C36)+(S2-1), (A1)+(A2)+(B1)+(B2)+(C37)+(S2-1), (A1)+(A2)+(B1)+(B2)+(C38)+(S2-1), (A1)+(A2)+(B1)+(B2)+(C39)+(S2-1), (A1)+(A2)+(B1)+(B2)+(C40)+(S2-1), (A1)+(A2)+(B1)+(B2)+(C41)+(S2-1), (A1)+(A2)+(B1)+(B2)+(C42)+(S2-1), (A1)+(A2)+(B1)+(B2)+(C43)+(S2-1), (A1)+(A2)+(B1)+(B2)+(C44)+(S2-1), (A1)+(A2)+(B1)+(B2)+(C45)+(S2-1), (A1)+(A2)+(B1)+(B2)+(C46)+(S2-1), (A1)+(A2)+(B1)+(B2)+(C47)+(S2-1), (A1)+(A2)+(B1)+(B2)+(C48)+(S2-1), (A1)+(A2)+(B1)+(B2)+(C49)+(S2-1), (A1)+(A2)+(B1)+(B2)+(C50)+(S2-1), (A1)+(A2)+(B1)+(B2)+(C51)+(S2-1), (A1)+(A2)+(B1)+(B2)+(C52)+(S2-1), (A1)+(A2)+(B1)+(B2)+(C53)+(S2-1), (A1)+(A2)+(B1)+(B2)+(C54)+(S2-1), (A1)+(A2)+(B1)+(B2)+(C55)+(S2-1), (A1)+(A2)+(B1)+(B2)+(C56)+(S2-1), (A1)+(A2)+(B1)+(B2)+(C57)+(S2-1), (A1)+(A2)+(B1)+(B2)+(C58)+(S2-1), (A1)+(A2)+(B1)+(B2)+(C59)+(S2-1), (A1)+(A2)+(B1)+(B2)+(C60)+(S2-1), (A1)+(A2)+(B1)+(B2)+(C61)+(S2-1), (A1)+(A2)+(B1)+(B2)+(C62)+(S2-1), (A1)+(A2)+(B1)+(B2)+(C63)+(S2-1), (A1)+(A2)+(B1)+(B2)+(C64)+(52-1), (A1)+(A2)+(B1)+(B2)+(C65)+(S2-1).

It may be appropriate to combine one or more herbicides (A) with one or more herbicides (B) and one or more herbicides (C), for example one herbicide (A) with one herbicide (B) and one or more herbicides (C). Herbicide combinations according to the invention comprising a plurality of herbicides (C) are, for example, those which, as component (C), contain the following herbicide combinations: C1+C18, C1+C15, C35 +C29, C35 +C1, C44+C45, C43+C45, C18+C1, C46+C32, C33+C34+C35 or C48+C57, preferred components (A) and (B) being the compounds (A1)+(B1), (A1)+(B2), (A2)+(B1) or (A2)+(B2), in particular (A1)+(B2), which herbicide combinations may additionally comprise a safener such as (S1-1), (S1-9) or (S2-1), in particular (S1-1). Furthermore, the herbicide combinations according to the invention may be applied together with other agrochemically active compounds, for example from the group of the safeners, fungicides, herbicides, insecticides and plant growth regulators, or with additives customary in crop protection and formulation auxiliaries. Additives are, for example, fertilizers and colorants. In each case, the ranges of application rates and the ratios of application rates mentioned above are preferred.

The combinations according to the invention (=herbicidal compositions) have excellent herbicidal activity against a broad spectrum of economically important mono- and dicotyledonous harmful plants. The active compound act efficiently even on perennial weeds which produce shoots from rhizomes, root stocks or other perennial organs and which are difficult to control. In this context, it is immaterial whether the substances are applied pre-sowing, pre-emergence or post-emergence. Preference is given to the application by the post-emergence method or the early post-sowing/pre-emergence method.

By way of example, some individual representatives of the mono- and dicotyledonous weed flora may be mentioned which can be controlled by the compounds according to the invention; however, this list is not to be understood as meaning a limitation to certain species.

Among the monocotyledonous weed species, the compounds act efficiently, for example, against Apera spica venti, Avena spp., Alopecurus spp., Brachiaria spp., Digitaria spp., Lolium spp., Echinochloa spp., Panicum spp., Phalaris spp., Poa spp., Setaria spp. and also Bromus spp., such as Bromus catharticus, Bromus secalinus, Bromus erectus, Bromus tectorum and Bromus japonicus, and Cyperus species from the annual group and, from among the perennial species, Agropyron, Cynodon, Imperata and Sorghum, and also perennial Cyperus species.

In the case of the dicotyledonous weed species, the spectrum of action extends to species such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. und Viola spp., Xanthium spp., Papaver rhoeas spp., Centaurea spp. among the annual species, and also Convolvulus, Cirsium, Rumex and Artemisia spp. among the perennial weeds.

If the herbicide combinations are applied to the soil surface prior to germination, then the weed seedlings are either prevented completely from emerging, or the weeds grow until they have reached the cotyledon stage but then their growth stops, and, eventually, after three to four weeks have elapsed, they die completely.

If the active compounds are applied post-emergence to the green parts of the plants, growth also stops drastically a very short time after the treatment and the-weed plants remain at the developmental stage of the point in time of application, or they die completely after a certain time, so that in this manner competition by the weeds, which is harmful to the crop plants, is eliminated at a very early point in time and in a sustained manner.

The herbicidal compositions according to the invention have a rapid and long-lasting herbicidal action. The shower resistance of the active compounds in the combinations according to the invention is generally favorable. It is a particular advantage that the effective dosages of compounds (A), (B) and (C) used in the combinations can be adjusted to such a low level, that their soil action is optimally low. Thus, it is not only possible to use them in sensitive crops, but groundwater contaminations are virtually avoided. By using the active compound combination according to the invention, it is possible to reduce the required application rate of the active compounds considerably.

When herbicides of type (A)+(B)+(C) are applied jointly, superadditive (=synergistic) effects are observed. Here, the activity in the combinations is stronger than the expected sum of the activities of the individual herbicides used. The synergistic effects permit a reduction of the application rate, the control of a broader spectrum of broad-leaved weeds and weed grasses, a more rapid onset of the herbicidal action, a longer duration of action, a better control of the harmful plants with only one or few applications and a widening of the possible period of use. In some cases, the use of compositions also reduces the amount of harmful ingredients, such as nitrogen or oleic acid, and their incorporation into the soil.

The abovementioned properties and advantages are needed in practical control of weeds to keep agricultural crops free of undesirable competing plants and thus to secure and/or increase the quality and quantity of the yields. With respect to the described properties, the prior art is considerably surpassed by these novel combinations.

Although the compounds according to the invention have an excellent herbicidal activity against monocotyledonous and dicotyledonous weeds, the crop plants are not damaged at all, or only to a negligible extent.

In addition, the compositions according to the invention have outstanding growth-regulating properties in crop plants. They engage in the plant metabolism in a regulating manner and can thus be employed for the targeted control of plant constituents and for facilitating harvesting, for example by provoking desiccation and stunted growth. Furthermore, they are also suitable for generally regulating and inhibiting undesirable vegetative growth, without destroying the plants in the process. Inhibition of vegetative growth plays an important role in many monocotyledonous and dicotyledonous crops because lodging can be reduced hereby, or prevented completely.

Owing to their herbicidal and plant growth-regulatory properties, the compositions according to the invention can be employed for controlling harmful plants in crop plants which are genetically modified or have been obtained by mutation/selection. These crop plants generally have particularly advantageous properties, for example resistance to herbicidal compositions or resistance to plant diseases or causative organisms of plant diseases, such as certain insects or microorganisms such as fungi, bacteria or viruses. Other particular properties relate, for example, to the quantity, quality, storage-stability, composition and to specific ingredients of the harvested product. Thus, for example, transgenic plants having an increased starch content or a modified quality of the starch or those having a different fatty acid composition of the harvested product are known.

Conventional ways for preparing novel plants which have modified properties compared to known plants comprise, for example, traditional breeding methods and the generation of mutants (see, for, example, U.S. Pat. No. 5,162,602; U.S. Pat. No. 4,761,373; U.S. Pat. No. 4,443,971). Alternatively, novel plants having modified properties can be generated with the aid of genetic engineering methods (see, for example, EP-A 0 221 044, EP-A 0 131 624). For example, there have been described several cases of
genetically engineered changes in crop plants in order to modify the starch synthesized in the plants (for example WO 92/11376, WO 92/14827, WO 91/19806),
transgenic crop plants which are resistant to other herbicides, for example sulfonylureas (U.S. Pat. No. 5,013,659),
transgenic crop plants having the ability to produce Bacillus thuringiensis toxins (Bt toxins) which impart resistance to certain pests to the plants (EP-A 0 142 924, EP-A 0 193 259),
transgenic crop plants having a modified fatty acid composition (WO 91/13972).

Numerous molecular biological techniques which allow the preparation of novel transgenic plants having modified properties are known in principle; see, for example, Sambrook et al., 1989, Molecular Cloning, A Laboratory Manual, 2nd ed. Cold Spring Harbor Laboratory Press, Cold Spring Harbor, N.Y.; or Winnacker “Gene und Klone” [Genes and Clones], VCH Weinheim, 2nd edition 1996, or Christou, “Trends in Plant Science” 1 (1996) 423-431).

In order to carry out such genetic engineering manipulations, it is possible to introduce nucleic acid molecules into plasmids which allow a mutagenesis or a change in the sequence to occur by recombination of DNA sequences. Using the abovementioned standard processes it is possible, for example, to exchange bases, to remove partial sequences or to add natural or synthetic sequences. To link the DNA fragments with each other, it is possible to attach adaptors or linkers to the fragments.

Plant cells having a reduced activity of a gene product can be prepared, for example, by expressing at least one appropriate antisense-RNA, a sense-RNA to achieve a cosuppression effect, or by expressing at least one appropriately constructed ribozyme which specifically cleaves transcripts of the abovementioned gene product.

To this end it is possible to employ both DNA molecules which comprise the entire coding sequence of a gene product including any flanking sequences that may be present, and DNA molecules which comprise only parts of the coding sequence, it being necessary for these parts to be long enough to cause an antisense effect in the cells. It is also possible to use DNA sequences which have a high degree of homology to the coding sequences of a gene product but which are not entirely identical.

When expressing nucleic acid molecules in plants, the synthesized protein can be localized in any desired compartment of the plant cell. However, to achieve localization in a certain compartment, it is, for example, possible to link the coding region with DNA sequences which ensure localization in a certain compartment. Such sequences are known to the person skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106).

The transgenic plant cells can be regenerated to whole plants using known techniques. The transgenic plants can in principle be plants of any desired plant species, i.e. both monocotyledonous and dicotyledonous plants. In this manner, it is possible to obtain transgenic plants which have modified properties by overexpression, suppression or inhibition of homologous (=natural) genes or gene sequences or by expression of heterologous (=foreign) genes or gene sequences.

Furthermore, the present invention also provides a method for controlling unwanted vegetation (for example harmful plants such as weeds or unwanted crop plants), preferably in crop plants such as cereals (for example wheat, barley, rye, oats, crossbreeds thereof, such as triticale, rice, corn, millet), sugar beet, sugar cane, oilseed rape, cotton and soybean, particularly preferably in monocotyledonous crops such as cereals, for example wheat, barley, rye, oats, crossbreeds thereof, such as triticale, rice, corn and millet, which method comprises applying one or more herbicides of the type (A) with one or more herbicides of type (B) and one or more herbicides of type (C) jointly or separately, for example by the pre-emergence method, the post-emergence method or the pre- and post-emergence method, to the plants, for example harmful plants, parts of plants, plant seed or the area on which the plants grow, for example the area under cultivation.

Here, unwanted plants are to be understood as meaning all plants which grow in locations where they are unwanted. These can be, for example, harmful plants (for example weeds or unwanted crop plants), including those, for example, which are resistant to certain herbicidally active compounds, such as glyphosate, atrazine, glufosinate or imidazolinones.

The crop plants may also be genetically modified or obtained by mutation/selection and are preferably tolerant to acetolactate synthase (ALS) inhibitors.

The invention also provides the use of the herbicide combinations according to the invention of compounds (A)+(B)+(C) for controlling harmful plants, preferably in crop plants.

The herbicidal compositions according to the invention can also be employed non-selectively for controlling unwanted vegetation, for example in plantation crops, on roadsides, squares, industrial sites or railway tracks.

The active compound combinations according to the invention can be present both as mixed formulations of components (A), (B) and (C), if appropriate with further agrochemically active compounds, additives and/or customary formulation auxiliaries, which are then applied in a customary manner diluted with water, or be prepared as so-called tank mixes by joint dilution of the separately formulated or partially separately formulated components with water. It is also possible to formulate and apply components (A), (B) and (C) separately, so that the active compound combination according to the invention is formed at the application site.

The compounds (A), (B) and (C) or their combinations can be formulated in various ways depending on the prevailing biological and/or chemico-physical parameters. Examples of general formulation options are: wettable powders (WP), water-soluble concentrates, emulsifiable concentrates (EC), aqueous solutions (SL), emulsions (EW), such as oil-in-water and water-in-oil emulsions, sprayable solutions or emulsions, suspension concentrates (SC), oil- or water-based dispersions, suspoemulsions, dusts (DP), seed-dressing compositions, granules for broadcasting and soil application, or water-dispersible granules (WG), ULV formulations, micro-capsules or waxes.

The individual formulation types are known in principle and are described, for example, in Winnacker-Küchler, “Chemische Technologie” [Chemical Technology], Volume 7, C. Hauser Verlag Munich, 4th ed. 1986; van Valkenburg, “Pesticide Formulations”, Marcel Dekker, N.Y., 1973; K. Martens, “Spray Drying Handbook”, 3rd ed. 1979, G. Goodwin Ltd. London.

The necessary formulation auxiliaries, such as inert materials, surfactants, solvents and other additives, are likewise known and are described, for example, in Watkins, “Handbook of Insecticide Dust Diluents and Carriers”, 2nd ed., Darland Books, Caldwell N.J., H. v. Olphen, “Introduction to Clay Colloid Chemistry”; 2nd ed., J. Wiley & Sons, N.Y.; C. Marsden, “Solvents Guide”; 2nd ed., Interscience, N.Y. 1950; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzflächenaktive Äthylenoxidaddukte” [Surface-active ethylene oxide adducts], Wiss. Verlagsgesellschaft, Stuttgart 1976; Winnacker-Küchler, “Chemische Technologie” [Chemical Technology], Volume 7, C. Hauser Verlag. Munich, 4th ed. 1986.

Based on these formulations it is also possible to produce combinations with other agrochemical active substances, such as other herbicides, fungicides or insecticides, and also with safeners, fertilizers and/or growth regulators, for example in the form of a ready-mix or tank mix.

Wettable powders are preparations which are uniformly dispersible in water and which contain, in addition to the active compound and as well as a diluent or inert substance, surfactants of ionic or nonionic type (wetting agents, dispersants), for example polyethoxylated alkyl phenols, polyethoxylated fatty alcohols, polyethoxylated fatty amines, alkanesulfonates, alkylbenzenesulfonates, sodium ligninsulfonate, sodium 2,2′-dinaphthylmethane-6,6′-disulfonate, sodium dibutylnaphthalene-sulfonate or else sodium oleoylmethyltaurinate.

Emulsifiable concentrates are prepared by dissolving the active compound in an organic solvent, for example butanol, cyclohexanone, dimethylformamide, xylene or else relatively high-boiling aromatic compounds or hydrocarbons with the addition of one or more surfactants of ionic or nonionic type (emulsifiers). Examples of emulsifiers which can be used are calcium alkylarylsulfonates, such as Ca dodecylbenzenesulfonate, or nonionic emulsifiers, such as fatty acid polyglycol esters, alkylaryl polyglycol ethers, fatty alcohol polyglycol ethers, propylene oxide-ethylene oxide condensation products, alkyl polyethers, sorbitan fatty acid esters, polyoxyethylene sorbitan fatty acid esters or polyoxyethylene sorbitol esters.

Dusts are obtained by grinding the active compound with finely divided solid substances, for example talc, natural clays, such as kaolin, bentonite and pyrophyllite, or diatomaceous earth.

Suspension concentrates (SC) can be water- or oil-based. They can be prepared, for example, by wet grinding using commercially available bead mills, if appropriate with addition of further surfactants, for example those already listed above for the other formulation types.

Emulsions, for example oil-in-water emulsions (EW), can be prepared, for example, by means of stirrers, colloid mills and/or static mixers using aqueous organic solvents and, if appropriate, further surfactants, for example those already listed above for the other formulation types.

Granules can be prepared either by spraying the active compound onto adsorptive, granulated inert material or by applying active-compound concentrates to the surface of carriers such as sand, kaolinites or granulated inert material, by means of adhesive binders, for example polyvinyl alcohol, sodium polyacrylate or else mineral oils. Suitable active compounds can also be granulated in the manner which is customary for the preparation of fertilizer granules, if desired as a mixture with fertilizers. Water-dispersible granules are generally prepared by customary processes such-as spray-drying, fluidized-bed granulation, disk granulation, mixing using high-speed mixers, and extrusion without solid inert material. For the preparation of disk, fluidized-bed, extruded and spray granules, see, for example, the methods in “Spray-Drying Handbook” 3rd ed. 1979, G. Goodwin Ltd., London; J. E. Browning, “Agglomeration”, Chemical and Engineering 1967, pages 147 ff.; “Perry's Chemical Engineer's Handbook”, 5th Ed., McGraw-Hill, New York 1973, pp. 8-57. For further details about the formulation of crop protection compositions see, for example, G. C. Klingman, “Weed Control as a Science”, John Wiley and Sons, Inc., New York, 1961, pages 81-96 and J. D. Freyer, S. A. Evans, “Weed Control Handbook”, 5th ed., Blackwell Scientific Publications, Oxford, 1968, pages 101-103.

The agrochemical formulations generally contain from 0.1 to 99% by weight, in particular from 2 to 95% by weight, of active compounds of types A and/or B and/or C, the following concentrations being customary, depending on the type of formulations: in wettable powders the concentration of active compound is, for example, from about 10 to 95% by weight, the remainder to 100% by weight consisting of customary formulation constituents. In emulsifiable concentrates the concentration of active compound can be, for example, from 5 to 80% by weight. Formulations in the form of dusts usually contain from 5 to 20% by weight of active compound, while sprayable solutions contain from about 0.2 to 25% by weight of. active compound. In the case of granules, such as dispersible granules, the content of active compound depends partly on whether the active compound is in liquid or solid form and on the granulation auxiliaries and fillers that are used. In water-dispersible granules the content is generally between 10 and 90% by weight.

In addition, said formulations of active compound may comprise the tackifiers, wetting agents, dispersants, emulsifiers, preservatives, antifreeze agents and solvents, fillers, colorants and carriers, antifoams, evaporation inhibitors and pH and viscosity regulators-which are customary in each case.

The herbicidal action of the herbicide combinations according to the invention can be improved, for example, by surfactants, preferably by wetting agents from the group of the fatty alcohol polyglycol ethers. The fatty alcohol polyglycol ethers preferably comprise 10-18 carbon atoms in the fatty alcohol radical and 2-20 ethylene oxide units in the polyglycol ether moiety. The fatty alcohol polyglycol ethers may be present in nonionic form, or ionic form, for example in the form of fatty alcohol polyglycol ether sulfates, which may be used, for example, as alkali metal salts (for example sodium and potassium salts) or ammonium salts, or even as alkaline earth metal salts, such as magnesium salts, such as C₁₂/C₁₄-fetty alcohol diglycol ether sulfate sodium (Genapol® LRO, Clariant GmbH); see, for example, EP-A-0476555, EP-A-0048436, EP-A-0336151 or U.S. Pat. No. 4,400,196 and also Proc. EWRS Symp. “Factors Affecting Herbicidal Activity and Selectivity”, 227-232 (1988). Nonionic fatty alcohol polyglycol ethers are, for example, (C₁₀-C₁₈)-, preferably (C₁₀-C₁₄)-fatty alcohol polyglycol ethers (for example isotridecyl alcohol polyglycol ethers) which comprise, for example, 2-20, preferably 3-15, ethylene oxide units, for example those from the Genapol® X-series, such as Genapol® X-030, Genapol® X-060, Genapol® X-080 or Genapol® X-150 (all from Clariant GmbH).

The present invention further comprises the combination of herbicides (A), (B) and (C) with the wetting agents mentioned above from the group of the fatty alcohol polyglycol ethers which preferably contain 10-18 carbon atoms in the fatty alcohol radical and 2-20 ethylene oxide units in the polyglycol ether moiety and which may be present in nonionic or ionic form (for example as fatty alcohol polyglycol ether sulfates). Preference is given to C₁₂/C₁₄-fatty alcohol diglycol ether sulfate sodium (Genapol® LRO, Clariant GmbH) and isotridecyl alcohol polyglycol ether having 3-15 ethylene oxide units, for example from the Genapol® X-series, such as Genapol® X-030, Genapol® X-060, Genapol® X-080 and Genapol® X-150 (all from Clariant GmbH). Furthermore, it is known that fatty alcohol polyglycol ethers, such as nonionic or ionic fatty alcohol polyglycol ethers (for example fatty alcohol polyglycol ether sulfates) are also suitable for use as penetrants and activity enhancers for a number of other herbicides, inter alia for herbicides from the group of the imidazolinones (for example EP-A-0502014).

The herbicidal action of the herbicide combinations according to the invention can also be enhanced by using vegetable oils. The term vegetable oils is to be understood as meaning oils of oleaginous plant species, such as soybean oil, rapeseed oil, corn oil, sunflower oil, cottonseed oil, linseed oil, coconut oil, palm oil, thistle oil or castor oil, in particular rapeseed oil, and also their transesterification products, for example alkyl esters, such as rapeseed oil methyl ester or rapeseed oil ethyl ester.

The vegetable oils are preferably esters of C₁₀-C₂₂-, preferably C₁₂-C₂₀-, fatty acids. The C₁₀-C₂₂-fatty acid esters are, for example, esters of unsaturated or saturated C₁₀-C₂₂-fetty acids, in particular those having an even number of carbon atoms, for example erucic acid, lauric acid, palmitic acid and in particular C₁₈-fatty acids, such as stearic acid, oleic acid, linoleic acid or linolenic acid.

Examples of C₁₀-C₂₂-fatty acid esters are esters obtained by reacting glycerol or glycol with the C₁₀-C22-fatty acids contained, for example, in oils of oleaginous plant species, or C₁-C₂₀-alkyl-C₁₀-C₂₂-fatty acid esters which can be obtained, for example, by transesterification of the glycerol- or glycol-C₁₀-C₂₂-fatty acid esters with C₁-C₂₀-alcohols (for example methanol, ethanol, propanol or butanol). The transesterification can be carried out by known methods as described, for example, in Römpp Chemie Lexikon, 9th edition, Volume 2, page 1343, Thieme Verlag Stuttgart.

Preferred C₁-C₂₀-alkyl-C₁₀-C₂₂-fatty acid esters are methyl esters, ethyl esters, propyl esters, butyl esters, 2-ethylhexyl esters and dodecyl esters. Preferred glycol- and glycerol-C₁₀-C₂₂-fatty acid esters are the uniform or mixed glycol esters and glycerol esters of C₁₀-C₂₂-fatty acids, in particular fatty acids having an even number of carbon atoms, for example erucic acid, lauric acid, palmitic acid and, in particular, C₁₈-fatty acids, such as stearic acid, oleic acid, linoleic acid or linolenic acid.

In the herbicidal compositions according to the invention, the vegetable oils can be present, for example, in the form of commercially available oil-containing formulation additives, in particular those based on rapeseed oil, such as Hasten® (Victorian Chemical Company, Australia, hereinbelow referred to as Hasten, main ingredient: rapeseed oil ethyl ester), Actirob®B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

In a further embodiment, the present invention comprises combinations of herbicides (A), (B) and (C) with the vegetable oils mentioned above, such as rapeseed oil, preferably in the form of commercially available oil-containing formulation additives, in particular those based on rapeseed oil, such as Hasten® (Victorian Chemical Company, Australia, hereinbelow referred to as Hasten, main ingredient: rapeseed oil ethyl ester), Actirob®B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

For use, the formulations, which are in commercially available form, are, if appropriate, diluted in a customary manner, for example using water in the case of wettable powders, emulsifiable concentrates, dispersions and water-dispersible granules. Preparations in the form of dusts, soil granules, granules for broadcasting and sprayable solutions are conventionally not diluted any further with other inert substances prior to use.

The active compounds can be applied to the plants, parts of the plants, seeds of the plants or the area under cultivation (tilled soil), preferably to the green plants and parts of the plants and, if desired, additionally to the tilled soil. A possible use is the joint application of the active compounds in the form of tank mixes, where the concentrated formulations of the individual active substances, in the form of their optimal formulations, are mixed jointly with water in the tank, and the spray mixture obtained is applied. A joint herbicidal formulation of the combination according to the invention of the active compounds (A), (B) and (C) has the advantage that it can be applied more easily.

### A. GENERAL FORMULATION EXAMPLES

a) A dust is obtained by mixing 10 parts by weight of an active compound/active compound mixture and 90 parts by weight of talc as inert substance and comminuting the mixture in a hammer mill.
b) A wettable powder which is readily dispersible in water is obtained by mixing 25 parts by weight of an active compound/active compound mixture, 64 parts by weight of kaolin-containing quartz as inert substance, 10 parts by weight of potassium lignosulfonate and 1 part by weight of sodium oleoylmethyltaurinate as wetting agent and dispersant, and grinding the mixture in a pinned-disk mill.
c) A dispersion concentrate which is readily dispersible in water is obtained by mixing 20 parts by weight of an active compound/active compound mixture with 6 parts by weight of alkylphenol polyglycol ether (Triton®) X 207), 3 parts by weight of isotridecanol polyglycol ether (8 EO) and 71 parts by weight of paraffinic mineral oil (boiling range for example approximately 255 to 277° C.) and grinding the mixture in a ball mill to a fineness of below 5 microns.
d) An emulsifiable concentrate is obtained from 15 parts by weight of an active compound/active compound mixture, 75 parts by weight of cyclohexanone as solvent and 10 parts by weight of ethoxylated nonylphenol as emulsifier.
e) Water-dispersible granules are obtained by mixing
   75 parts by weight of an active compound/active compound mixture,
   10 parts by weight of calcium lignosulfonate,
   5 parts by weight of sodium lauryl sulfate,
   3 parts by weight of polyvinyl alcohol and
   7 parts by weight of kaolin,
   grinding the mixture in a pinned-disk mill and granulating the powder in a fluidized bed by spraying on water as granulation liquid.
f) Water-dispersible granules are also obtained by homogenizing and precomminuting, in a colloid mill,
   25 parts by weight of an active compound/active compound mixture,
   5 parts by weight of sodium 2,2′-dinaphthylmethane-6,6′-disulfonate,
   2 parts by weight of sodium oleoylmethyltaurinate,
   1 part by weight of polyvinyl alcohol,
   17 parts by weight of calcium carbonate and
   50 parts by weight of water,
   subsequently grinding the mixture in a bead mill and atomizing and drying the resulting suspension in a spray tower by means of a single-substance nozzle.

### B. BIOLOGICAL EXAMPLES

Herbicidal Action (Field Trials)

The seeds or rhizome pieces of the harmful plants and the useful plants were laid out or were present in the soil, and they were grown under natural outdoor conditions. Treatment with the active compounds or active compound combinations was carried out after, before and/or after the emergence of the plants, generally at the 2- to 4-leaf stage, in various dosages using a water application rate of 100 to 400 l/ha (converted).

After the application (about 4 weeks after the application), the effectiveness of the active compounds or active compound combinations was scored visually by comparing the treated plots to untreated control plants. During scoring, damage and development of all above-ground parts of plants was assessed. Scoring was carried out using a percentage scale (100% effect=all plants had died; 50% effect=50% of the plants and the green parts of the plants have died; 0% effect=no effect observed=like control plant). In each case, the mean score of 2-4 plots was calculated.

The results are shown in the table below; the effect of the individual application of active compounds (A+B) and C being stated in brackets.

| | | Application rate | | |
|---|---|---|---|---|
| | | g of active | Veronica | Triticum |
| | Active | substance/ | hederifolia | aestivum |
| | compounds | hectare | % effect | % damage |
| A | mesosulfuron- | 5 | 7 | 2 |
| | methyl | | | |
| B | propoxycarba- | 30 | 30 | 3 |
| | zone-sodium | | | |
| A + B | | 5 + 30 | 45 | 4 |
| C | mecoprop-P | 250 | 35 | 0 |
| A + B + C | | 5 + 30 + 250 | 98 (45 + 35) | 3 |

1. A herbicide combination having an effective content of components (A), (B) and (C), wherein
(A) is one or more herbicides selected from the group consisting of the compounds of the formula (I) and their salts, 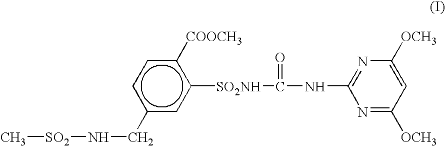
(B) is one or more herbicides selected from the group consisting of the compounds of the formula (II) and their salts, 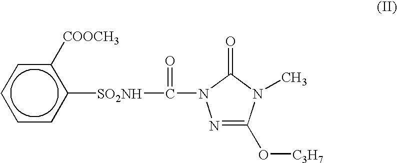
(C) is one or more herbicides selected from the group consisting of the compounds
(C1) diflufenican
(C2) imazamox
(C3) florasulam
(C4) halosulfuron
(C5) tritosulfuron
(C6) picolinafen
(C7) cinidon-ethyl
(C8) mesotrione
(C9) metosulam
(C10) clopyralid
(C11) flufenacet
(C12) flumetsulam
(C13) flupoxam
(C14) prosulfocarb
(C15) flurtamone
(C16) aclonifen
(C17) fenoxaprop
(C18) isoproturon
(C19) diclofop
(C20) clodinafop
(C21) chlortoluron
(C22) methabenzthiazuron
(C23) imazamethabenz
(C24) tralkoxydim
(C25) difenzoquat
(C26) flamprop
(C27) pendimethalin
(C28) mecoprop
(C29) MCPA
(C30) dichlorprop
(C31) 2,4-D
(C32) dicamba
(C33) fluroxypyr
(C34) ioxynil
(C35) bromoxynil
(C36) bifenox
(C37) fluoroglycofen
(C38) lactofen
(C39) pyraflufen
(C40) flucarbazone
(C41) bentazone
(C42) amidosulfuron
(C43) metsulfuron
(C44) tribenuron
(C45) thifensulfuron
(C46) triasulfuron
(C47) chlorsulfuron
(C48) flupyrsulfuron
(C49) fluazolate
(C50) sulfosulfuron
(C51) glufosinate
(C52) glyphosate
(C53) sulcotrione
(C54) cycloxydim
(C55) sethoxydim
(C56) clethodim
(C57) carfentrazone
(C58) imazethapyr
(C59) imazaquin
(C60) imazapyr
(C61) imazapic
(C62) beflubutamid
(C63) fentrazamide
(C64) flufenacet and
(C65) amicarbazone.

2. The herbicide combination as claimed in claim 1 wherein component (A) is mesosulfuron-methyl, mesosulfuron-methyl-sodium, salt or a combination thereof and, component (B) is propoxycarbazone, propoxycarbazone-sodium salt or a combination thereof.

3. The herbicide combination as claimed in claim 1 further comprising one or more components selected from the group consisting of agrochemically active compounds crop protection additives and formulation auxiliaries.

4. The herbicide combination as claimed in claim 1 further comprising one or more safeners.

5. The herbicide combination as claimed in claim 1 further comprising one or more fatty alcohol polyglycol ethers, one or more vegetable oils, or a combination thereof.

6. A method for controlling unwanted plants comprising applying the herbicides (A), (B) and (C), defined in claim 1, together or separately to any portion of the plant or plant seeds or the area on which the plants grow.

7. The method as claimed in claim 6 for the selective control of harmful plants in crop plants.

8. The method as claimed in claim 7 for controlling harmful plants in monocotyledonous crop plants.

9. The method as claimed in claim 7 wherein the crop plants are genetically modified or obtained by mutation/selection.

10. (canceled)

11. The herbicide combination as claimed in claim 2 further comprising one or more components selected from the group consisting of agrochemically active compounds crop protection additives and formulation auxiliaries.

12. The herbicide combination as claimed in claim 3 further comprising one or more safeners.

13. The herbicide combination as claimed in claim 4 further comprising one or more fatty alcohol polyglycol ethers, one or more vegetable oils, or a combination thereof.

14. A method for controlling unwanted vegetation comprising applying the herbicides (A), (B) and (C), defined in claim 2, together or separately to any portion of the plant or plant seeds or the area on which the plants grow.

15. The method as claimed in claim 8 wherein the crop plants are genetically modified or obtained by mutation/selection
